(19) United States
(12) Patent Application Publication
(10) Pub. No.: US 2005/0288450 A1
(43) Pub. Date: Dec. 29, 2005

(54) Coating matting agent comprising amide condensation product

(76) Inventor: Tim Fletcher, Worms (DE)

Correspondence Address: GRACE GMBH & CO. KG, 7500 GRACE DRIVE, COLUMBIA, MD, 21044, US

(21) Appl. No.: 11/203,595

(22) Filed: Aug. 15, 2005

Related U.S. Application Data
(63) Continuation-in-part of application No. 10/516,196.

(51) Int. Cl. C08L 77/00; B32B 27/34

(52) U.S. Cl. 525/420; 428/474.4

(57) ABSTRACT

The compounds of this invention are suitable matting agents for coatings. The compounds are amide-containing condensation products optionally comprising at least one β-hydroxyalkylamide functional group and, for example, are prepared from monomeric amides, oligomeric polyamides or polymeric polyamides bearing β-hydroxyalkylamide groups by reacting the hydroxyalkylamide bearing amide with another compound such that at least one reactive functional group other than β-hydroxyalkylamide is also present on the condensation product, and further such that 50% or more of the terminal β-hydroxyalkylamide functionality has been reacted or converted to groups containing terminal carboxylic acid groups or other reactive groups including, but not limited to, groups reactive with polymers and crosslinkers suitable for preparing epoxy, epoxy-polyester, polyester, polyester acrylic, polyester-primid, polyurethane or acrylic coatings. Other embodiments of the invention comprise the combination of the aforementioned condensation product with inorganic solids such as silicas and aluminas, and/or matte activators.

### BACKGROUND

This invention relates to products suitable for use as a matting agent in coating formulations, and in particular condensation products containing at least one amide or ester amide group, optionally at least one β-hydroxyalkylamide group, and at least one reactive functional group other than a β-hydroxyalkylamide.

Many compounds containing β-hydroxyalkylamide groups have been disclosed in the patent literature for purposes of preparing polymers and crosslinkers for surface coatings. Particularly mentioned are water-borne coatings and powder coatings.

U.S. Pat. No. 3,709,858 refers to high gloss water-borne coatings prepared from polyester-amide polymers containing both hydroxyl and carboxylic acid group functionality. The β-hydroxyalkylamide chemistry arose from the use of a substantial amount of an N,N-bis [2-hydroxyalkyl]-2-hydroxyethoxyacetamide as one of the polyol monomers. Amide groups would have been present terminally and in the polymer backbone and β-hydroxyalkylamide end groups would also have been present to an extent dependent in part on the proportion of N,N-bis[2-hydroxyalkyl]-2-hydroxyethoxyacetamide used. The molecular weight of the polymers would have been comparatively low and in examples were about 1000 or less.

Primid XL552 from Rohm & Haas is an example of a β-hydroxyalkylamide-based crosslinker. It has been used with increasing success in curing carboxyl bearing polyester-based resins to produce glossy powder coatings. Such powder coatings are generally intended for outdoor use. Compounds such as Primid XL552 can be obtained by the reaction of di-esters of carboxylic acids with aminoalcohols such as those disclosed in U.S. Pat. No. 4,076,917. A typical example would be the dimethylester of adipic acid reacted with diethanolamine or disopropanolamine.

In addition to the reaction products of saturated or unsaturated monomeric di-esters of carboxylic acids with aminoalcohols as monomeric crosslinkers for polymers bearing one or more carboxylic or anhydride functions, U.S. Pat. No. 4,076,917 further discloses polymers containing pendant β-hydroxyalkylamide groups as crosslinkers and self-curing polymers containing both β-hydroxyalkylamide groups and carboxylic acid groups. Acrylate based polymers were specifically discussed where copolymerization with β-hydroxyalkylamide compounds containing vinyl groups was performed. Patents relating to these latter aspects are U.S. Pat. No. 4,138,541; U.S. Pat. No. 4,115,637; and U.S. Pat. No. 4,101,606. U.S. Pat. No. 4,801,680 describes powder coating compositions obtained by crosslinkers of the type given in U.S. Pat. No. 4,076,917 with carboxylic acid bearing polyester resins.

U.S. Pat. No. 5,589,126 discloses linear or branched amorphous or semi-crystalline copolyesters of molecule weight between 300 and 15000 containing two or more terminal β-hydroxyalkylamide groups for use as crosslinkers with carboxylic acid bearing polymers such as are employed in powder coatings. Hydroxy numbers are between 10 and 400 mg KOH/g. The polymers are obtained by producing hydroxyl terminated polyesters, esterification with diesters of carboxylic acids and subsequent reaction with aminoalcohols.

WO 99/16810 describes linear or branched polyester-amides having a weight average molecular weight of not less than 800 g/mol where at least one amide group is in the polymer backbone and having at least one terminal β-hydroxyalkylamide group. The polymers may be entirely or partly modified with monomers, oligomers or polymers containing reactive groups that can react with β-hydroxyalkylamide groups where crosslinking is preferably avoided by using monomers, oligomers or polymers that contain only one group that can react with the β-hydroxyalkylamide group e.g. monofunctional carboxylic acids. The polymers may be obtained by reaction of a cyclic anhydride with an aminoalcohol with subsequent polycondensation between the resulting functional groups such that the mole ratio of alkanolamine to anhydride is preferably greater than 1:1.

It is mentioned in WO 99/16810 that it is surprising that the polyester-amides disclosed are capable of giving good flow and film properties in powder coatings because previous use of reactive polymers having functionality greater than 6′ in powder coatings are normally associated with poor appearance and poor film properties. The terminal β-hydroxyalkylamide groups accordingly are modified to an extent less than 50% and preferably less than 30%.

U.S. Pat. No. 6,645,636 describes a polyesteramide polymer having at least two carboxylic end groups connected to an alkylamine group via an ester linkage and obtained by polycondensation of an alkanolamine and a cyclic anhydride such that the mole ratio of alkanolamine to anhydride is preferably less than 0.5:1.

WO 01/16213 describes a process to prepare polymers similar to those described in WO 99/16810, but that process involves reacting a polycarboxylic acid with an aminoalcohol followed by polycondensation in order to produce a polymer employed as a crosslinker that does not release cyclic anhydrides when acid functional polyesters such as those used in powder coatings are cured.

The above references describe chemistries primarily designed to improve coatings exhibiting glossy finishes and are for the most part silent towards modifying those formulations to obtain flat or matted finishes. Indeed, there is considerable interest in matte coatings, which retain the good film properties of their glossy counterparts.

Solid particles such as silicas and to a lesser extent, aluminas, carbonates and talcs are widely used to matt conventional solvent-borne and water-borne liquid coatings, examples being coil coatings, wood coatings and many other general industrial coatings. The matting of conventional coatings, where the coating in question contains a sufficient number of particles in the size range of about 2 to 20 μm, is often regarded as depending on the coating layer shrinking in thickness during film formation due to solvent release or release of water in the case of water-borne coatings and gloss is generally a smoothly decreasing function of addition level.

Larger particles are generally associated with matting more effectively than smaller particles although this relationship can depend on the thickness of the coating. Further, if the particle size is too high then the coating surface takes on an unacceptably rough nature, whereas if the particle size is too low, the surface roughness created does not have the necessary dimensions to diffusely scatter light effectively, which is the ultimate cause of the matt appearance.

This approach is however a relatively ineffective method of matting difficult to matt coatings such as powder coatings, high solids coatings and many radiation curing coatings due to their low, minimal and ideally zero volatile organic content and the consequent absence of significant shrinkage during film formation.

In conventional coatings, it is usually found that reducing gloss by the use of solid particles like silica leads to a reduction in important film properties such as flexibility, durability, surface mechanical properties, adhesion and also curing properties. Many such film properties are directly related to the particle volume fraction in the dry coating and to varying degrees the surface area, surface chemistry and size of the particles. The use of solid particles may also have a negative influence on the rheological properties of the coating in liquid form, as viscosity for example is proportional to the volume occupied by the particles, the structural units that may form and the available surface area, which is dependent in turn on the internal particle structure and the particle size.

The degree of matting is also a direct function of the particle volume fraction and as noted, the particle size to the extent that the particle volume fraction is itself not a function of particle size as it may be in highly porous structures. Consequently, there is often little scope to try and limit the difficulties associated with the reciprocal situation just depicted in a broadly based sense except through changes in the particle size distribution.

Attempts have been made to lower the gloss of difficult to matt systems by increasing the concentration of relatively large sized silicas and other fillers sufficiently. However, as is to be expected, rheological problems become even more severe in these cases and film properties also tend to degrade as the concentration of particles increases. In powder coatings for example, high melt viscosities due to high filler contents may render the process of extrusion more difficult and high wear of powder coating manufacturing and application equipment may also be a consequence of high filler content, due to increased abrasivity.

Hydrocarbon and fluorocarbon waxes of varying types are used to improve certain surface properties of conventional coatings such as mar resistance, metal marking and surface slip and have been used in combination with silicas and other fillers to try and offset some of the negative features experienced in coatings matted in this way. Fillers, partially coated with a layer of hydrocarbon wax are also sometimes employed as one means of avoiding hard settlement of the filler. In conventional liquid coatings, waxes of suitable particle size which are not soluble in the organic phase and which retain their particulate nature may additionally impart matting properties to the coating.

Waxes have also been employed alone or in combination with fillers to reduce gloss in difficult to matt systems. Thus, some hydrocarbon waxes are claimed to have gloss reduction capabilities in certain types of UV curable coatings, provided that the rate of curing is not too high. Certain types of waxes, particularly those based on polyethylene, polypropylene and teflon particles embedded in a polypropylene matrix and having a suitable melting point are also claimed to have moderate to high gloss reducing properties when employed as additives in powder coatings.

In these cases though, It is generally found that if the melting point is less than the cure temperature, or the initially matted coating containing wax is subsequently exposed to temperatures that exceed the melting point of the wax, then glossy films can result. Controlled exudation or localised surface enrichment of the coating surface by the wax is often invoked to explain the effects that waxes can have in conventional coatings as well as in difficult to matt coatings under appropriate conditions.

Like fillers, the use of waxes in difficult to matt coatings is associated with several disadvantages. Gloss reduction is not always highly reproducible. The surface active nature of some waxes may also influence application properties of coatings due to foam formation, cratering and other film defects. Additionally, an undesirably greasy film surface may result due to exudation of the wax depending on the extent of incompatibility of the wax with the polymeric component of the powder coating. As the addition level to attain a given gloss increases, the wax may also have a significant plasticising effect and whilst this can improve film flexibility, the coating may in fact become softer and consequently lack mark, abrasion, stain and chemical resistance. In the case of powder coatings, a plasticising action may also lead to coalescence problems during storage of the powder prior to use.

With regard to powder coatings, the limited success of conventional matting agents and waxes has led to the development of a number of new approaches to matting. For example, it has been shown that powder coatings can be matted by (1) dry blending powders having different reactivity or flow capability, (2) co-extruding two powder coating compositions having different reactivity or even different reactive chemistry, (3) adding special curing agents having limited compatibility with the powder coating polymer, (4) use of polymer binders having a high degree of branching with reactive end-groups, specifically polyesters derived from 2,2-bis-(hydroxymethyl)-propionic acid in polyurethane powder coatings and (5) crosslinkers bearing two types of functional groups capable of participating in reaction with polymers or polymer blends themselves having different functional groups being related again to polyurethane powder coatings.

The last two examples have been used with polyurethane powder coatings, while the first three mentioned have been used with epoxy, polyester-epoxy and polyurethane coatings whereas matting of polyester powder coatings tends to rely on the use of dry blends. It is apparent that although low values of gloss below 20 at 60° can be obtained using current matting products or techniques in specific formulations of a given powder coating type, it has often been difficult to retain other desirable film properties such as flexibility, hardness, solvent resistance, outdoor durability and resistance to yellowing during film cure.

In the light of the above, it is therefore an object of this invention to obtain matting agents which can generate acceptable matte finishes in coatings, reproducibly, but at the same time maintain other desirable coating properties. It is also a goal to provide a method in which conventional matting agents and other particulate substances can be used in the matting agent, or combined with matting agents of the first objective, yet attain acceptable matte finishes, as well as maintain those desirable coating features mentioned above. An ability to reduce the particulate volume fraction needed to attain a given gloss level, is in itself, expected from the above discussion, to result in a number of benefits.

### BRIEF DESCRIPTION OF DRAWINGS

FIG. 1 illustrates a method for making β-hydroxyalkylamide compounds and subsequent reactions with a compound having functional groups other than β-hydroxyalkylamide for making a condensation product of this invention.

FIG. 2 illustrates an alternate process for preparing condensation product of this invention.

FIG. 3 illustrates viscoelastic data of a conventional polyester powder coating during curing where the crosslinker is a conventional hydroxyalkylamide crosslinker.

### SUMMARY OF THE INVENTION

The compounds of this invention are amide-containing condensation products comprising, optionally, at least one β-hydroxyalkylamide functional group, and at least one reactive functional group other than a β-hydroxyalkylamide group. Such products can, for example, be prepared as monomeric amides or ester-amides, and linear or branched, oligomeric or polymeric amides or ester-amides. The condensation products of this invention, however, contain terminal or pendent carboxylic acid groups or other desirable functional groups with respect to the nature of the coating that is to be matted and may be prepared such that the a β-hydroxyalkylamide functionality is present in an amount of no more than 50% of the total functionality on a mole basis. The total functionality is at least two functional groups (identical or different) per molecule.

Preferred functional groups of this invention comprise carboxylic acid groups, or carboxylic acid groups in combination with β-hydroxyalkylamide groups where the latter are present to an extent of no more than 50% of the total functionality on a mole basis. Additional preferred functional groups include alkoxysilane groups. These compounds are compatible with and reactive with many types of polymers and inorganic solids typically employed in coatings. Given the reactivity of the β-hydroxyalkylamide group, other reactive groups can be readily introduced depending on the specific coating to be matted such as hydroxyl groups, epoxy groups, isocyanate groups and unsaturated groups such as methacrylate groups. Thus, other reactive groups include, but are not limited to, those reactive with epoxy, polyester, epoxy-polyester, polyester-primid, polyurethane, acrylic polymers and radiation curing polymers which are employed as binders in typical coatings and with inorganic solids such as silicas and aluminas.

Another embodiment of the present invention relates to a coating including an amide or ester-amide having a functionality of at least 4, wherein the coating possesses a gloss at 60° of about 80 or less. Preferably, the coating possesses at 60° a gloss of about 70 or less, more preferably the coating possesses a 60° gloss of about 60 or less, and even more preferably the coating possesses a 60° gloss of about 50 or less. The amide or ester-amide may be a monomer, oligomer, or polymer, and may include at least one reactive functional group such as carboxyl, isocyanate, epoxide, hydroxyl and alkoxy silane. The amide or ester-amide may also include at least one β-hydroxyalkylamide functional group wherein the β-hydroxyalkylamide functional group is 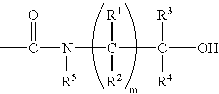
R¹, R², R³ and R⁴ may, independently of one another, be the same or different, H, straight or branched chain alkyl, (C₆-C₁₀) aryl or R¹ and R³ or R² and R⁴ may be joined to form, together with the combinations, a (C₃-C₂₀) cycloalkyl radical; m is 1 to 4 and R⁵ is 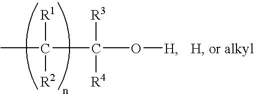
and R¹, R², R³, R⁴ and m as defined above.

A further embodiment of the present invention relates to a coating including an amide or ester-amide, wherein the amide or ester-amide provides a reduction in gloss of the coating. Preferably, the amide or ester-amide provides a reduction in gloss of at least about 5 at 60°, more preferably the amide or ester-amide provides a reduction in gloss of at least about 10 at 60°, and even more preferably, the amide or ester-amide provides a reduction in gloss of at least about 15 at 60°. The amide or ester-amide may also provide improved impact resistance, solvent resistance, scratch resistance, durability, and/or adhesion to the coating.

Another embodiment of the invention comprises the combination of the aforementioned condensation product with inorganic solids such as silicas, aluminas, silicates and aluminosilicates. Such combinations can provide additional control over the rheological processes occurring during film formation, thereby leading to enhanced matting and coating performance properties. In cases where the matting agent should be a solid, easier handling of the organic condensation product component from a health and safety point of view and easier incorporation of the organic component into a coating in case the desirable organic component in question is liquid or semi-solid can result. Additionally, milling of the organic component in the presence of an inorganic solid to a suitable particle size can be more conveniently carried out, and the latter's use can result in a product which can be incorporated into a coating with relative ease and uniformity.

Another embodiment comprises combining the condensation product with a matte activator, e.g., a suitable catalyst or coreactant for the coating binder. These embodiments showed improved matting and film properties over those in which the condensation product is employed without, e.g., a catalyst or coreactant.

As indicated above, the condensation products of the invention can be prepared by reacting an amide, or an ester-amide, bearing terminal or pendent β-hydroxyalkylamide groups, with another compound bearing the other reactive functional groups, or acting as a precursor to other reactive functional groups, or acting as a precursor in the sense that the other reactive groups arise from further reactions which may include addition polymerisation reactions. The two components, however, are reacted such that the gel point is not reached or exceeded during manufacture. It has been found that when the total functionality or average number of functional groups per molecule of the condensation product exceeds four, the product imparts a matting effect to coatings.

In further aspects, the invention relates to compounds comprising the condensation products and inorganic oxides, or comprising condensation products and matte activators or to compounds comprising all three components for use as a matting agent in coatings, where the term matte activator will be defined below.

The invention also relates to such condensation products and compounds suitable for use as a matting agent in liquid coatings, for use in matted coatings to enhance the efficiency of conventional matting agents and for improving various aspects of the performance properties of a matted coating such as flexibility, durability, surface mechanical properties and adhesion. Besides powder coatings, the type of coatings in which these products and compounds are suitable concern most forms of solvent-borne and water-borne coatings including coil coatings, radiation cured coatings and high solids coatings.

### DETAILED DESCRIPTION

This invention relates to products suitable for use as a matting agent in coating formulations, and in particular condensation products containing at least one amide or ester-amide group, optionally at least one β-hydroxyalkylamide group, and at least one reactive functional group other than a β-hydroxyalkylamide, such that not more than 50% of the total reactive group functionality is composed of β-hydroxyalkylamide groups and where the overall functionality exceeds 4. The term condensation product will be defined below.

In further aspects, the invention relates to compounds comprising the condensation products and inorganic oxides, or comprising condensation products and matte activators or to compounds comprising all three components for use as a matting agent in coatings, where the term matte activator will be defined below.

The invention also relates to such condensation products and compounds suitable for use as a matting agent in liquid coatings, for use in matted coatings to enhance the efficiency of conventional matting agents and for improving various aspects of the performance properties of a matted coating such as flexibility, durability, surface mechanical properties and adhesion. Besides powder coatings, the type of coatings in which these products and compounds are suitable concern most forms of solvent-borne and water-borne coatings including coil coatings, radiation cured coatings and high solids coatings.

Besides coatings, condensation products and compounds falling within the chemical scope described here would likely provide considerable benefits in a broad range of other polymer based materials such as adhesives, additives to improve adhesion of coatings to plastics or in rubber to metal bonding, hot melt polymers, sealants, inks, surface treatments for fibre reinforcements in reinforced plastics, surface treatments for the paper industry and in the ink-jet industry. Condensation products and compounds falling within the general chemical scope described here would likely have considerable value as rheological control agents, as adhesion promotors, as corrosion inhibitors and as corrosion inhibiting additives for coatings and polymer based materials.

As defined in the present application, an amide is described as a substance containing at least one amide group and at least one reactive functional group. The amide substance may be monomeric being regarded in that case as a fairly well-defined substance, or it may be oligomeric or polymeric in nature, in which case a size distribution of species will be involved. The amide substance may contain β-hydroxyalkylamide groups only. The amide substance may contain other reactive functional groups such as carboxylic acid groups, alkoxysilane groups, isocyanate groups unsaturated groups or hydroxy groups apart from β-hydroxyalkylamide groups. It may also contain a mixture of reactive groups including β-hydroxyalkylamide groups.

At least one amide group will invariably arise from the introduction or presence of a β-hydroxyalkylamide group or a residue thereof, but it may also arise or be present as part of the basic chemical structure in monomeric substances, or in the case of oligomers and polymers as a unit of the chain structure where the presence of such amide groups is desirable. Oligomers and polymers may be of a variety of condensation and addition types such as polyesters, polyamides, polyester-amides, polyurethanes and acrylics and hybrids thereof

β-hydroxyalkylamide

The condensation product of this invention can be prepared from compounds bearing terminal β-hydroxyalkylamide groups. Amide or ester-amide compounds bearing terminal β-hydroxyalkylamide groups are in general known, e.g., Primid® additives from Rhom & Haas, and examples of methods for making such compounds are disclosed in U.S. Pat. Nos. 4,076,917; U.S. Pat. No. 3,709,858; U.S. Pat. No. 4,727,111; U.S. Pat. No. 5,116,922; U.S. Pat. No. 4,138,541, U.S. Pat. No. 5,889,126, U.S. Pat. No. 6,392,006, U.S. Pat. No. 3,331,892, U.S. Pat. No. 3,625,988, U.S. Pat. No. 3,324,033, U.S. Pat. No. 4,446,301, U.S. Pat. No. 4,245,086, U.S. Pat. No. 6,133,405. U.S. Pat. No. 5,101,073, U.S. Pat. No. 4,146,590 and U.S. Pat. No. 4,687,834, the contents of which are incorporated herein by reference.

Thus, compounds bearing terminal β-hydroxyalkylamide groups may, for example, be prepared from the reaction between (1) monomeric dialkyl ester derivatives of dicarboxylic acids and (2) β-aminoalcohols, which may in general be monoalkanolamines, dialkanolamines or trialkanolamines.

In a variant of this method, oligomeric or polymeric substances containing on average two or more terminal ester groups can be used in place of the monomeric diester. These oligomeric or polymeric species may be obtained by transesterification of monomeric or polymeric polyols with a suitable excess of a monomeric diester. Subsequent reaction of these oligomeric or polymeric species with a suitable aminoalcohol results in a compound containing two or more β-hydroxyalkylamide groups. The actual number of groups will of course depend on whether a monoalkanolamine, a dialkanolamine or a trialkanolamine is used.

The species containing terminal ester groups may be replaced with derivatives of monomeric cyclic anhydrides or polyanhydrides. In this case, an addition reaction between the anhydride and aminoalcohol takes place to produce a monomeric compound bearing carboxylic acid groups and β-hydroxyalkylamide groups. In a further reaction step, this monomeric compound may be polymerised by a condensation reaction between the carboxylic acid groups and β-hydroxyalkylamide groups to produce a polymeric compound bearing at least one terminal β-hydroxyalkylamide group. The number of β-hydroxyalkylamide groups remaining after such a reaction depends on whether monoalkanolamines, dialkanolamines or trialkanolamines are employed and also on whether the anhydride is a monoanhydride or a polyanhydride.

Whether obtained by the reaction of an ester with an aminoalcohol or an anhydride with an aminoalcohol, it is apparent that a compound bearing terminal a β-hydroxyalkylamide groups may itself act as a polyol. It may also be reacted with a suitable excess of a monomeric diester to produce species containing on average one or more terminal alkyl ester groups for further reaction with aminoalcohols.

Oligomeric or polymeric substances bearing ester groups mentioned above as suitable for manufacturing the hydroxyalkylamide compounds can be obtained by transesterification of monomeric alkyl esters of di- or polyfunctional carboxylic acids with di- or polyfunctional alcohols in either melt form or in solvent at a temperature in the range of 50° C. to 275° C. in the presence of suitable catalysts, such as, for example, metal carboxylates like zinc acetate, manganese acetate, magnesium acetate or cobalt acetate as well as metal alkoxides like, tetraisopropyl titanate, or sodium methoxide.

Oligomeric or polymeric derivatives bearing terminal ester groups may also be obtained by a conversion reaction of hydroxyl-functional polyesters with monomeric alkylesters of di- or polycarboxylic acids, either in melt form or in suitable solvents at a temperature in the range of 50° C. to 275° C. in the presence of suitable catalysts.

Hydroxyl-functional polyesters may be obtained by conventional polymerization techniques involving di- and polyfunctional carboxylic acids with di- and polyfunctional alcohols. Hydroxyl-functional polyesters with on average a higher degree of branching may be obtained if required by polymerisation of suitable polyhydroxycarboxylic acids according to methods described for example in U.S. Pat. No. 3,669,939, U.S. Pat. No. 5,136,014 and U.S. Pat. No. 5,418,301, the contents of which are incorporated by reference.

Hydroxy-functional polyesters can also be prepared via esterification and ester interchange reactions or via ester interchange reactions. Suitable catalysts for those reactions include, as an example, dibutyl tin oxide or titanium tetrabutylate.

Suitable hydroxy-functional polyester resins have a hydroxyl value of 10-500 mg KOH/g.

The monomeric alkyldiesters of polycarboxylic acids indicated in the above reactions include dimethyl terephthalate, dimethyl adipate, dimethyl sebacate and dimethylhexahydroteraphthalate.

Examples of suitable di- and polyfunctional carboxylic acid components in the above reactions include, but are not limited to, aromatic multi-basic carboxylic acids such as terephthalic acid, isophthalic acid, phthalic acid, pyromellitic acid, trimellitic acid, 3,6-dichlorophthalic acid, tetrachlorophathalic acid, and their anhydride, chloride or ester derivatives, together with aliphatic and/or cycloaliphatic multi-basic acids such for example as 1,4-cyclohexanedicarboxylic acid, tetrahydrophthalic acid, hexahydroendomethylene terephthalic acid, hexachlorophthalic acid, C₄-C₂₀ dicarboxylic acids such as, for example, azelaic acid, sebacic acid, decandicarboxylic acid, adipic acid, dodecandicarboxylic acid, succinic acid, maleic acid, as well as dimeric fatty acids and their anyhdride, chloride and ester derivatives. Hydroxycarboxylic acids and/or lactones such as, for example, 12-hydroxystearic acid, epsilon-Caprolacton or hydroxypivalic acid ester of neopentyl glycol, can likewise be used. Monocarboxylic acids, such as, for example, benzoic acid, tertiary butylbenzoic acid, hexahydrobenzoic acid and saturated aliphatic monocarboxylic acids may also be used as required.

The following aliphatic diols are named by way of example of suitable difunctional alcohols mentioned above: ethylene glycol, 1,3-propanediol, 1,2 propanediol, 1,2 butanediol, 1,3-butanediol, 1,4 butanediol, 2,2-dimethylpropane1,3-diol (neopentyl glycol), 2,5-hexandiol, 1,6-hexandiol, 2,2-[bis-(4 hydroxycyclohexyl)]propane, 1,4 dimethylolcyclohexane, diethylene glycol, dipropylene glycol and 2,2-bis-[4-(2-hydroxy)]phenylpropane.

Suitable polyfunctional alcohols mentioned above are glycerol, hexanetriol, pentaeryltritol, sorbitol, trimethylolethane, trimethylolpropane and tris(2-hydroxy)isocyanurate. Epoxy compounds can be used instead of diols or polyols. Alkoxylated diols and polyols are also suitable.

2,2-bis-(hydroxymethyl)-propionic acid, 2,2-bis-(hydroxymethyl)-butyric acid, 2,2-bis-(hydroxymethyl)-valeric acid, 2,2,2-tris-(hydroxymethyl)-acetic acid and 3,5.dihydroxybenzoic acid may be mentioned as examples of polyhydroxylcarboxylic acids. These monomers would for example allow the preparation of polymers bearing pendent carboxylic acid groups.

In all of the above, previously prepared compounds containing terminal β-hydroxyalkylamide groups may also be employed instead of or in addition to the above-mentioned di- and polyfunctional alcohols.

In all of the above, mixtures of various polyols, polybasic carboxylic acids and hydroxyl- and polyhydroxylcarboxylic acids or mixtures of their corresponding oligomers or polymers and their corresponding ester terminated analogues can be used.

In the above, the ratio of ester groups to hydroxyl groups in the conversion reaction between the diester and the hydroxyl bearing substance varies with the nature of the polyol, its functionality, the desired material and the need to avoid gelation. If for example the average functionality of the polyol is three, the minimum proportion of polyol to diester is such that the ratio of hydroxyl to ester groups is 0.5. If the average functionality of the polyol is six, the minimum proportion of polyol to diester is such that the ratio of hydroxyl to ester groups is 0.3

As mentioned above, derivatives of monomeric cyclic anhydrides or polyanhydrides can be used instead of diester derivatives to prepare the hydroxylalkylamide compound. Polyanhydrides include polymers with pendent anhydride groups such as polymers and copolymers of maleic anhydride.

A preferable cyclic anhydride is a mono anhydride according to formula I: 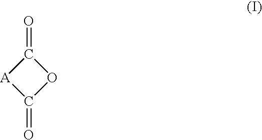
in which A has the meaning specified later below.

Examples of suitable cyclic anhydrides include phthalic anhydride, tetrahydrophthalic anhydride, naphtalenic dicarboxylic anhydride, hexahydrophthalic anhydride, 5-norbornene-2,3-dicarboxylic anhydride, norbornene-2,3-dicarboxylic anhydride, naphtalenic dicarboxylic anhydride, 2-dodecene-1-yl-succinic anhydride, maleic anhydride, (methyl)succinic anhydride, glutaric anhydride, 4-methylphthalic anhydride, 4-methylhexahydrophthalic anhydride, 4-methyltetrahydrophthalic anhydride and the maleinised alkylester of an unsaturated fatty acid.

Preferably the aminoalcohol reactive with the ester or anhydride is a compound according to the Formula II: 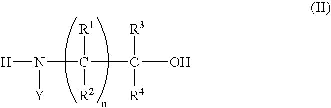
in which: 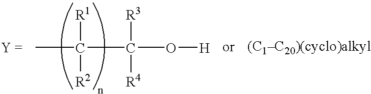
R¹, R², R³, and R⁴ may, independently of one another, be the same or different, and includes, but is not limited to, H, or substituted or unsubstituted alkyl (linear or branched), (C₆-C₁₀) aryl (C₁-C₂₀)(cyclo)alkyl radical. Generally n=1-4, but more preferably, n=1.

The aminoalcohol may be a monoalkanolamine, a dialkanolamine, a trialkanolamine or a mixture hereof.

Dialkanolamines are preferred, but if monoalkanolamines are used in the reaction with cyclic anhydrides, in order to obtain polymers bearing a β-hydroxyalkylamide groups with a functionality of 2 or greater, polyanhydrides would need to be employed so as to provide sufficient functionality to produce a final product having the desired functionality. Similarly, if monoalkanolamines are employed in the reaction with oligomeric or polymeric substances bearing ester groups, the substances would need an average functionality of at least two ester groups to produce polymers bearing β-hydroxyalkylamide groups with a functionality of 2 or greater.

If a highly branched structure with relatively high functionality is desired, di- or trialkanolamines may be used.

Overall therefore, depending on the application desired, a linear or an entirely or partly branched oligomer or polymer bearing β-hydroxyalkylamide groups can be chosen, in which further moderation of the structure can be attained via the alkanolamines selected for preparation of the desired oligomer or polymer.

Examples of suitable mono-a β-alkanolamines include 2-aminoethanol(ethanolamine), 2-(methylamino)-ethanol, 2-(ethylamino)-ethanol, 2-(butylamino)-ethanol, 1-methyl ethanolamine (isopropanolamine), 1-ethyl ethanolamine, 1-(m)ethyl isopropanolamine, n-butylethanolamine, a β-cyclohexanolamine, n-butyl isopropanolamineand 2-Amino-1-propanol.

Examples of suitable di-β-alkanolamines are diethanolamine (2,2′-iminodiethanol), 3-amino-1,2-propanediol, 2-amino-1,3-propanediol, diisobutanolamine (bis-2-hydroxy-1-butyl)amine), di-β-cyclohexanolamine and diisopropanolamine (bis-2-hydroxy-1-propyl)amine).

A suitable trialkanolamine is, for example, tris(hydroxymethyl)aminomethane. Use of this monomer would for example allow the introduction of oxazoline groups into the polymer backbone.

In a number of instances, alkanolamines with β-alkyl-substitution are preferably used. Examples are (di)isopropanolamine, cyclohexyl isopropanolamine, 1-(m)ethyl isopropanolamine, (di)isobutanolamine, di-β-cyclohexanolamine and/or n-butyl isopropanolamine.

The ester:alkanolamine amine equivalent ratio is generally, in the range of 1:0.5 to 1:1.5 and more typically in the range of 1:0.8 to 1:1.2.

Alkanolamines reacted in suitable ratios with the ester terminated compound or used as a monomer to prepare the ester terminated compound would provide a means of introducing an amide group into the polymer backbone.

The anhydride: aminoalcohol equivalent ratio is dependent upon the anhydride, but generally is between 1.0:1.0 and 1.0:1.8. Preferably, this ratio is between 1:1.05 and 1:1.5.

When an anhydride is reacted with an aminoalcohol, the reaction may be carried out by reacting the anhydride and aminoalcohol at a temperature between, for example, about 20° C. and about 100° C., to form a substantially monomeric hydroxyalkylamide, after which, at a temperature between, for example, 120° C. and 250° C., a polyesteramide is obtained through polycondensation with water being removed through distillation.

Excess aminoalcohol may be required when employing this procedure to regulate molecular weight build-up. Alternatively, use of a monofunctional a β-hydroxyalkylamide group containing compound or monofunctional carboxylic acid compound to moderate the functionality may be employed depending on the final compound desired. A further moderating procedure, which may be used separately or in combination with the previously mentioned options is to employ a compound containing 2 or more β-hydroxyalkylamide groups, but no other reactive group capable of reacting with a β-hydroxyalkylamide group. These are similar techniques to those employed to prepare polyesters with terminal hydroxyl groups with varying degrees of branching such as is for example described in U.S. Pat. No. 5,418,301, the contents of which are incorporated by reference.

When an ester containing compound is reacted with an aminoalcohol, the reaction can be carried out at a temperature between 20° C. and 200° C., more typically 80° C. to 120° C., optionally in the presence of suitable catalysts such as metal hydroxides, metal alkoxides, quaternary ammonium hydroxides and quaternary phosphonium compounds. The alcohol arising from the reaction is removed by distillation. The proportion of catalyst may typically range from 0.1% to 2% by weight.

The reactions can take place in a melt phase, but also in water or in an organic solvent.

The removal of water or alcohol through distillation can take place at a pressure higher than 1 bar, under reduced pressure, azeotropically under normal conditions of pressure, with co-distillation of solvent or with the aid of a gas flow.

Using derivatives discussed above, specific β-hydroxyalkylamides according to the Formula (III) below can be prepared: 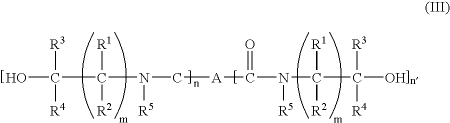
wherein A is a bond, hydrogen or a monovalent or polyvalent organic radical derived from a saturated or unsaturated alkyl radical wherein the alkyl radical contains from 1-60 carbon atoms, such as methyl, ethyl, propyl, butyl, pentyl, hexyl, heptyl, octyl, nonyl, decyl, eicosyl, triacontyl, tetracontyl, pentacontyl, hexylcontyl and the like; substituted or unsubstituted aryl, for example, C₂-C₂₄ mono- and dinuclear aryl such as phenyl, naphthyl and the like; C₁-C₈ cycloalkyl, diradical, tri-lower alkyleneamino such as trimethyleneamino, triethyleneamino and the like; or an unsaturated radical containing one or more ethylenic groups [>C═C<] such as ethenyl, 1-methylethenyl, 3-butenyl-1,3-diyl, 2-propenyl-1,2-diyl, carboxy lower alkenyl, such as 3-carboxy-2-propenyl and the like; lower alkoxy carbonyl lower alkenyl such as 3-methoxycarbonyl-2-propenyl and the like.

R⁵ is hydrogen, alkyl, preferably of from 1-5 carbon atoms such as methyl, ethyl, n-propyl, n-butyl, sec-butyl, tert-butyl, pentyl and the like or hydroxy lower alkyl preferably of from 1-5 carbon atoms such as hydroxyethyl, 3-hydroxypropyl, 2-hydroxypropyl, 4-hydroxybutyl, 3-hydroxybutyl, 2-hydroxy-2-methylpropyl, 5-hydroxypentyl, 4-hydroxypentyl, 3-hydroxypentyl, 2-hydroxypentyl and the isomers of pentyl; R⁵ can also be Y in Formula II above.

R¹ R², R³ and R⁴ preferably are the same or different radicals selected from hydrogen, straight or branched chain alkyl, preferably of from 1-5 carbon atoms, or R¹ and R³ or R² and R⁴ radicals may be joined to form, together with the carbon atoms, a C₃-C₂₀ such as cyclopentyl, cyclohexyl and the like; m is an integer having a value of 1 to 4; n is an integer having a value of 1 or 2 and n′ is an integer having a value of 0 to 2. When n′ is 0, A can be a polymer or copolymer (i.e., n has a value greater than 1 formed from an unsaturated radical.

More specific compounds are those of the foregoing Formula III, wherein R⁵ is H, lower alkyl, or HO(R³) (R⁴)C(R¹)(R²)C—, n and n′ are each 1, -A- is —(CH₂)ₘ—, m is 0-8, preferably 2-8, each R group is H, and one of R³ or R⁴ radicals in each case is H and the other is H or a C₁-C₅ alkyl; that is, of formula (IV) 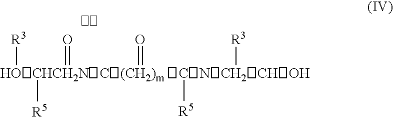
(wherein R⁵, R³, and m have the meanings given above.

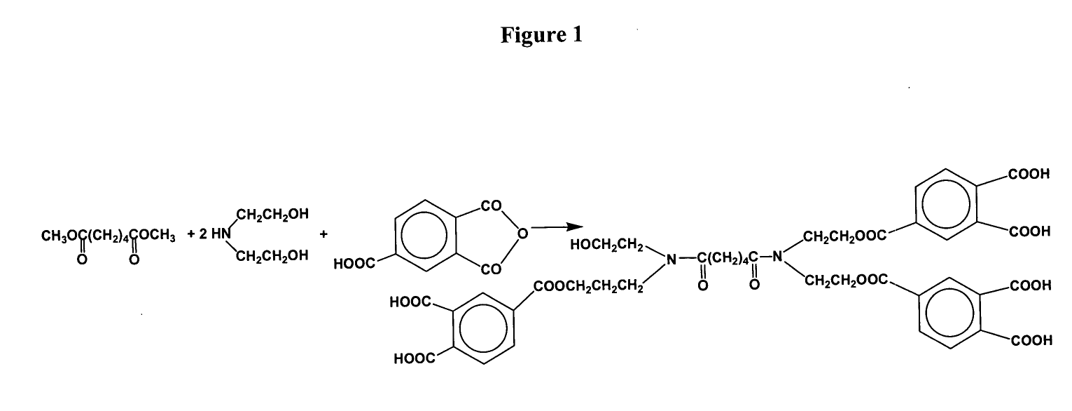

Specific examples falling within Formula IIII are bis[N,N-di(β-hydroxyethyl)]adipamide, bis[N,N-di(β-hydroxypropyl)] succinamide, bis[N,N-di(β-hydroxyethyl)]azelamide, bis[N—N-di(β-hydroxypropyl)] adipamide, and bis[N-methyl-N-(β-hydroxyethyl)] oxamide. A method for making a suitable hydroxyalkylamide is illustrated in FIG. 1.

Specific β-hydroxyalkylamides also are those of the foregoing Formula III where A is a polyester polymer chain which is either linear or branched, where optionally the chain contains amide or ester-amide groups. Accordingly, A can additionally comprise ester amides alternating along a polymeric backbone, or in the case of a branched structure, the ester and amide linkages alternate among the main and side chains of the branched structure. When A represents an addition polymer, a large range of vinyl and acrylic monomers are available to form the polymer or copolymer such as styrene, methyl methacrylate, maleic anhydride, methyl vinyl ether, acrylic acid, methacrylic acid, glycidyl acrylate, glycidyl methacrylate and those described in for example U.S. Pat. No. 4,076,917 and U.S. Pat. No. 4,727,111.

Other Reactive Functional Group

The β-hydroxyalkylamide selected and/or prepared can then be reacted with a compound bearing functional groups or precursors to functional groups other than a hydroxyalkylamide group. That compound is a monomer, oligomer or polymer which in addition to the group which is not a hydroxyalkylamide, contains at least one functional group that can react with a hydroxyalkylamide group. In some cases, the compound bearing the functional groups or precursors to functional groups may after reaction with a suitable hydroxyalkylamide compound be subject to additional polymerisation to produce the final condensation product bearing the desired functional groups. In the same way, pendent or terminal ester groups present on the β-hydroxyalkylamide may be used as an additional means of introducing desired reactive groups by means of compounds capable of reacting with ester groups.

Compounds bearing such functional groups or precursors to such functional groups include cyclic anhydrides, monomeric or polymeric polycarboxylic acids or polycarboxylic acid anhydrides containing one or more anhydride groups per molecule and one or more free carboxylic acid groups per molecule, which after reaction with the β-hydroxyalkylamide, results in free carboxylic acid groups remaining. Specific examples of carboxylic acids and anhydrides include, but are not limited to, adipic acid, decanedicarboxylic acid, trimellitic anhydride, phthalic acid or phthalic anhydride, tetrahydrophthalic acid or tetrahydrophthalic anhydride, hexahydrophthalic acid, tetrahydrophthalic anhydride, tetrahydrophthalic acid, hexahydrophthalic anhydride, pyromellitic acid, pyromellitic anhydride, 3,3′, 4,4′-tetra-benzophenone carboxylic acid anhydride and combinations thereof.

Other suitable carboxylic acid compounds are, for example, dimer or trimer acids of saturated aliphatic (C₁-C₂₆) acids, unsaturated (C₁-C₃₆) fatty acids, hydroxycarboxylic acids and polyhydroxycarboxylic acids such as 2,2-bis-(hydroxymethyl)-propionic acid as well as β, β-unsaturated acids.

Examples of suitable α, β-unsaturated acids are (meth)acrylic acid, crotonic acid and monoesters or monoamides of itaconic acid, maleic acid, 12-hydroxystearic acid, polyether carboxylic acid, and fumaric acid.

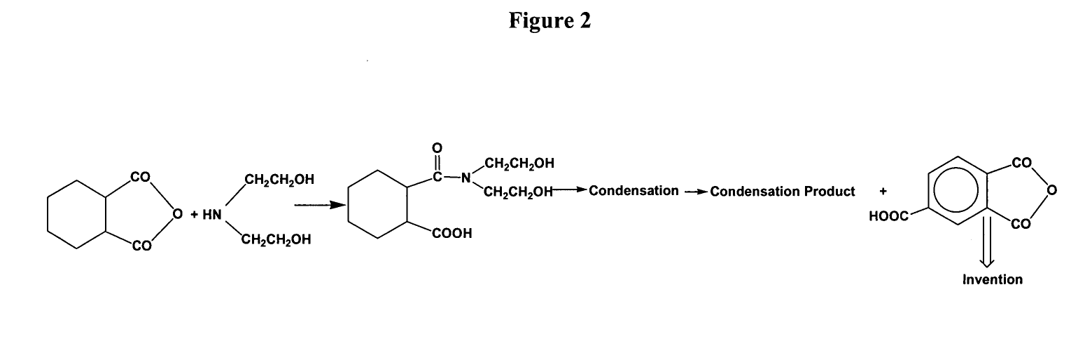

When polycarboxylic acids are used, the functional groups on the final condensation product of this invention would be predominantly free carboxylic acid groups. The use of cyclic anhydrides or polycarboxylic acid anhydrides on the other hand allows selective reaction of the anhydride groups with the β-hydroxyalkylamide groups under conditions such that the free carboxylic acid groups are substantially unreactive. In this way, compounds containing both types of groups can be prepared. FIG. 2 illustrates a method for making the final ester-amide condensation product of the invention using anhydrides.

Examples of other suitable reactive groups include, but are not limited to, isocyanate groups, epoxy groups, alkoxysilane groups, acid chloride groups, epoxychlorohydrine groups, amine groups, phenolic groups, methylolated amide groups, hydroxyl groups, methylol groups and combinations hereof.

Examples of suitable isocyanates include, but are not limited to, diisocyanates such as 1,4-diisocyanato-4-methyl-pentane, 1,5-diisocyanato-5-methylhexane, 3(4)-isocyanatomethyl-1-methylcyclohexylisocyanate, 1,6-diisocyanato-6-methylheptane, 1,5-diisocyanato-2,2,5-trimethylhexane and 1,7-diisocyanato-3,7-dimethyloctane, and 1-isocyanato-1-methyl-4-(4-isocyanatobut-2-yl)-cyclophexane, 1-isocyanato-1,2,2-trimethyl-3-(2-isocyanato-ethyl)-cyclopentane, 1-isocyanato-1,4-dimethyl-4-isocyanatomethyl-cyclohexane, 1-isocyanato-1,3-dimethyl-3-isocyanatomethyl-cyclohexane, 1-isocyanatol-n-butyl-3-(4-isocyanatobut-1-yl)-cyclopentane and 1-isocyanato-1,2-dimethyl-3-ethyl-3-isocyanatomethyl-cyclopentane, respectively.

In the event oligomeric or polymeric esters are used to prepare the a β-hydroxyalkylamide compound, such derivatives may be reacted with cyclic anhydrides, polycarboxylic acids or polycarboxylic acid anhydrides just as when using monomeric esters.

In the event the initially formed β-hydroxyalkylamide compound contains more than two β-hydroxyalkylamide groups per molecule, one or more such groups can be blocked by reaction with a suitable monofunctional reagent such as a monofunctional carboxylic acid prior to reaction with a polycarboxylic acid or a polycarboxylic acid anhydride or other desirable reactive groups.

Compounds may be prepared with a variety of other reactive groups. By way of example, epoxy groups could be introduced by reacting the a β-hydroxyalkylamide group with a compound such as epichlorohydrin. Similarly, hydroxy groups could be introduced by means of suitable hydroxyacids such as 2,2-bis-(hydroxymethyl)-propionic acid and mercapto groups by means of mercaptoacids such as thiogylcollic acid. Alkoxysilane groups can result by use of suitable organofunctional silanes such as 3-ureidopropyltriethoxysilane.

The above examples refer to direct conversion of the β-hydroxyalkylamide group. As indicated above, in some cases, it may be preferable to obtain the desired reactive group indirectly in more than one stage. Thus by way of example, initial conversion to hydroxyl groups or carboxylic acid groups could be followed by reaction with isocyanate compounds to introduce isocyanate groups or with glycidyl alkoxysilanes such as glycidoxypropyltrimethoxy silane as well as the higher alkoxy analogues to introduce alkoxysilane groups.

Such isocyanate groups could also be used to introduce alkoxysilane groups by reaction with aminosilanes an example being aminopropyltrimethoxysilane or the higher alkoxy analogues. Carboxylic acid groups could also be introduced by reaction of cyclic anhydrides with hydroxyl groups obtained by prior reaction of the α, β-hydroxyalkylamide group with a suitable hydroxyacid.

Additional polymerisation may be used to introduce a variety of functional groups by copolymerisation through double bonds of monomers such as methyl (meth)acrylate and styrene with the appropriate functional group containing monomers such as a, β-unsaturated acids, gylcidyl acrylate or methacrylate and hydroxyethyl acrylate, having first reacted the β-hydroxyalkylamide group with a suitable compound containing a carbon—carbon double bond such as an α, β-unsaturated acid, maleic anhydride, glycidyl acrylate and so on.

Obviously, a large number of possibilities exist here by suitable selection of the starting monomer for initial conversion of the β-hydroxyalkylamide to introduce the desired functional group.

Compounds bearing unsaturated groups such as vinyl or allyl groups generally defined as a carbon-carbon double bond can of course also be introduced by direct or indirect conversion, avoiding any subsequent addition polymerisation using previously mentioned substances such as maleic anhydride, itaconic anhydride, alpha, beta-unsaturated acids and glycidyl (meth) acrylate, as well as allyl alcohol, allyl amine, cinnamic acid and so on.

Thus, these methods essentially involve preparing amide or ester-amides, having β-hydroxyalkylamide groups and subsequently reacting at least one of these groups with cyclic anhydrides, polycarboxylic acids, polycarboxylic acid anhydrides, or other suitable compounds as described above depending on the desired structure and functional group. Not more than 50% of the total reactive groups in the final condensation product are β-hydroxyalkylamide groups. The various reactions may be carried out in one or more steps according to well known polymerization and sequential functionalization techniques. The final amides or ester-amides may be monomeric, oligomeric or polymeric in nature.

Condensation Product

In general, the average number (mole basis) of desired functional groups per molecule or “functionality” present in the condensation product of this invention after reacting the β-hydroxyalkylamide with, for example, cyclic anhydrides, can range from 4 to 48, preferably at least 8, and more preferably in the range of 8-24 functional groups per molecule, but whereby not more than 50% of the total number of functional groups per molecule are β-hydroxyalkylamide groups. In other words, at least fifty percent of the functional groups (on a mole basis) are groups other than a β-hydroxyalkylamide group. Desired functional group content by weight ranges from 50 to 750 mgKOH/g.

The number average molecular weight of the final condensation product ranges from 300 to 15,000, preferably 1000-5000.

As indicated earlier, the reactive functional groups on the final molecule of the condensation product are selected depending on the particular polymer binder of the coating in which the product will be added as a matting agent. The binders typically used in coatings include, but are not limited to, epoxy-polyesters, epoxies, polyesters, polyester-acrylics, polyester-primids, polyurethane, polyester-aminos, alkyds and acrylics. Epoxy-polyesters are frequently used binders, and carboxylic functionality would be a preferred reactive functional group for a matting agent intended for such binders. The reactive groups may also be selected based on the type of inorganic solid with which the condensation product is to be combined with.

The condensation product, which may be solid, liquid, or semi-solid may be prepared in the melt phase, or may be prepared in a suitable organic solvent, for example an aprotic solvent such as dimethylacetamide or N-methyl-2-pyrrolidone or other suitable solvent.

If it is desired to obtain the condensation product in a solvent free form, solvents such as N-methyl-2-pyrrolidone can subsequently be removed by distillation. However, due to the high boiling point and high heat of vaporization, large amounts of energy would be needed for this operation. Moreover, it is usually difficult to ensure substantially complete removal of such solvents in this way due to the strong interactions existing between the solvent and the solute. An alternative method is to extract the solvent into a second solvent such that the solute is not soluble in the solvent mixture. A suitable second solvent in many of the present cases is water, but may for example also be alcohols or water-alcohol mixtures. Further counter-current washing of the precipitated product with water or the second solvent may be carried out as necessary to ensure substantial removal of the first solvent.

The solvent solution of the product may be added under intense stirring to the second solvent, for example as droplets or as a continuous stream of material such that the precipitated product, if solid, is present substantially in a particulate form. In some cases, this process may be aided by the presence of an inorganic solid. This is particularly helpful if the precipitated organic product does not have a solid-like character. The resulting product may finally be dried at temperatures not exceeding 100° C.

Drying at temperatures above the glass transition temperature of the condensation product can lead to the product flowing and binding any inorganic components that may be present, resulting in bonded agglomerates. In this form, the condensation product may not readily dissolve in otherwise suitable solvents and may not readily disperse throughout the coating. With certain embodiments it may be preferable to obtain the condensation product in the pure state (without inorganic particulate) by the above method of solvent extraction. In this case, the particulate form resulting from the procedure may be lost if the drying temperature is too high.

In order to avoid these problems, when the product is dried it is preferable to dry it under reduced pressure. This may for example be carried out in a vacuum oven or in a rotational evaporator equipped with facilities for application of a vacuum. A final rinse with a volatile water miscible solvent such as acetone, methyl ethyl ketone, methanol, ethanol or isopropanol after water washing such that the final solvent does not dissolve the organic component may be carried out prior to drying. Alternatively, the product may be reslurried/redissolved in solvents such as acetone, methyl ethyl ketone, methanol, ethanol or isopropanol, in water or in combinations thereof and the product recovered by drying.

Either of the above problems may also be avoided by spray drying a solution of product together with an inorganic solid if desired in order to obtain a final product having a suitable particulate form. Suitable solvents may for example be selected from alcohols, water/alcohol mixtures and ketones. Alternatively, condensation products may simply be prepared in the pure or neat state and subsequently mixed with the inorganic solid. Co-milling may be employed as required or desired.

The overall approach therefore avoids high temperatures that would otherwise make it difficult to prepare compounds containing two or more types of functional groups that are reactable with one another. Any esterification and transesterification catalysts that are used during the chemical reactions leading to the final product can also be extracted to the extent that they are soluble in the second solvent and to the extent that their removal is desirable.

Besides solvent extraction techniques, various solvent exchange techniques can also be employed, if it is desired to obtain the condensation product or the condensation product and inorganic solid in solvents other than the reaction solvent. Thus, solutions and dispersions in ketones, esters, hydrocarbons or water may be preferable, depending on the nature of the coating. The use of solvent exchange techniques may also be helpful where the desired inorganic solids are themselves dispersed in water or solvents such as colloidal silicas, aluminas and other small particle dispersions. Removal of more volatile solvent components by distillation is another option that can be helpful in obtaining the final product in a desired medium.

Where the condensation product is prepared entirely in the melt phase, obtaining the product in a suitable particulate form may be achieved by the techniques mentioned above. For example, the melt may be run into a stirred non-organic solvent such as water, or the material may be dissolved in a suitable solvent and the resulting solution spray dried. However, the most straightforward procedure would be to cool the product and to simply pulverize the solidified material to a suitable particle size.

In an alternative procedure, it may be possible in some cases to blend the reagents together in an aqueous or organic solvent phase including any inorganic solid to be present in the final product as required, dry the resultant mixture, and complete any remaining reaction or polymerization steps in the solvent-free state or solid state as appropriate.

In any of the above instances, a suitable average particle size for the matting agent product in order to facilitate it into the final coating mixture is regarded as ranging from about 1 μm to about 100 μm and preferably not greater than 50 μm. The final product may subsequently be pulverized or milled if required. Any final milling step should be carried out at suitably low temperatures in the event only condensation product is in the final matting agent product.

The amount of condensation product added to the coating depends on the amounts of other additives included in the formulation, e.g., other additives such as a matte activator and other optional additives discussed below. In general, the amounts of condensation product to be added can range from about 0.5% to 20% based on the total weight of the coating formulation. Preferably the amount ranges from about 1% to 10% based on the weight of binder in the coating formulation. NOTE: This paragraph disagrees with paragraph 0157.

A mixture of different condensation products, each falling within the scope of the invention may also be employed in the coating formulation.

It is also suitable to combine the invention with β-hydroxyalkylamides containing more than 50% β-hydroxyalkylamide functionality insofar as the overall active functionality of the combination comprises no more than 50% β-hydroxyalkylamide.

Inorganic Particulate Additives

Inorganic particulates suitable for incorporation with the condensation product include those inorganic-based matting agents employed in conventional solvent borne coatings. They also include aqueous and solvent dispersions of inorganic particulates.

Silica particulates are suitable. These particulates range in average particle size from 1 to 20 microns, preferably 5 to 10 microns. Porous silicas, such as silica gels and precipitated silicas, are usually preferred for their matting efficiency. Silica gels, for example, have pore volumes ranging from 0.5 to 2.0 cc/g, preferably 1.0 to 2.0 cc/g. Particle sizes mentioned above are those reported using a Coulter Counter and the pore volume is that obtained using nitrogen porosimetry. Suitable silica gels and methods for making them are described in U.S. Pat. No. 4,097,302, the contents of which are incorporated by reference. Particulated aluminum oxide or metal silicates and aluminosilicates in the size ranges above are also suitable, as are colloidal silicas and aluminas. NOTE: The ratio of particulate to condensation product has been left out.

If an inorganic particulate is to be present in the final matting compound together with a condensation product, dry-blending, co-milling, kneading, extrusion or other suitable mixing technique, after preparation of the condensation may be performed according to the physical form of the condensation product. The inorganic component such as a silica or alumina may be added at any suitable stage of the reaction sequences leading to the condensation product. As mentioned above, the inorganic component may also be added to a suitable solution, slurry or dispersion of the condensation product.

Solid product may subsequently be pulverized or milled as required. The final product should be milled to that having an average particle size suitable for facilitating it into the final coating mixture. Suitable average particle sizes for the final matting agent product range from about 0.1 μm to about 50 μm.

Matte Activator

As indicated above, matte activators may also be used in combination with condensation product of this invention to prepare a preferred matting agent. A matte activator includes, but is not limited to, compounds such as catalysts or coreactants known in the art. These activators accelerate or facilitate matting, facilitate curing of the powder coating to which the invention is added and promote formation of films having the desired properties. The selected activator depends on the binder in the powder coating. A catalyst suitable as an activator hereunder can be defined as a compound left unchanged after the reaction of the invention and powder coating binder and is usually used in relatively small amounts. A coreactant suitable hereunder, which may be present in varying amounts, is used up as it participates and is usually consumed in the aforementioned reaction. Quaternary phosphonium halides and quaternary phosphonium phenoxides and carboxylates such as those described in EP 019 852 or U.S. Pat. No. 4,048,141, the contents of which are incorporated herein by reference, are particularly suitable matte activators.

Preferred phosphonium-based matte activators are represented by the formula (V): 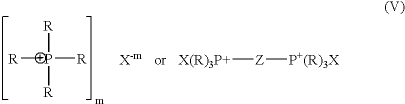
wherein each R is independently a hydrocarbyl or inertly substituted hydrocarbyl group, Z is a hydrocarbyl or inertly substituted hydrocarbyl group and X is any suitable anion.

The term “hydrocarbyl” as employed herein means any aliphatic, cycloaliphatic, aromatic, or aliphatic or cycloaliphatic substituted aromatic groups. The aliphatic groups can be saturated or unsaturated. Those R groups which are not aromatic contain from 1 to 20, preferably from 1 to 10, more preferably from 1 to 4 carbon atoms.

The term “inertly substituted hydrocarbyl group” means that the hydrocarbyl group can contain one or more substituent groups that does not enter into the reaction and does not interfere with the reaction between the epoxy compound and the polyester. Suitable such substituent groups include for example, NO₂, Br, Cl, I, F.

Suitable anions include, but are not limited to, halides such as, for example, chloride, bromide, iodide and the carboxylates as well as the carboxylic acid complexes thereof, such as formate, acetate, propionate, oxalate, trifluoroacetate, formateformic acid complex, acetateacetic acid complex, propionatepropionic acid complex, oxalateoxalic acid complex, trifluoroacetatetrifluoroacetic acid complex. Other suitable anions include, for example, phosphate, and the conjugate bases of inorganic acids, such as, for example, bicarbonate, phosphate, tetrafluoroborate or biphosphate and conjugate bases of phenol, such as, for example phenate or an anion derived from bisphenol A.

Some of the catalysts are commercially available; however, those which are not can be readily prepared by the method described by Dante et al. in the aforementioned U.S. Pat. No. 3,477,990, by Marshall in the aforementioned U.S. Pat. No. 4,634,757 and by Pham et al. in the aforementioned U.S. Pat. No. 4,933,420. Examples of the above-mentioned phosphonium catalysts include, among others, methyltriphenylphosphonium iodide, ethyltriphenylphosphonium iodide, propyltriphenylphosphonium iodide, tetrabutylphosphonium iodide, methyltriphenylphosphonium acetateacetic acid complex, ethyltriphenylphosphonium acetateacetic acid complex, propyltriphenylphosphonium acetateacetic acid complex, tetrabutylphosphonium acetateacetic acid complex, methyltriphenylphosphonium bromide, ethyltriphenylphosphonium bromide, propyltriphenylphosphonium bromide, tetrabutylphosphonium bromide, ethyltriphenylphosphonium phosphate, benzyl-tri-para-tolylphosphonium chloride, benzyl-tri-para-tolylphosphonium bromide, benzyl-tri-para-tolylphosphonium iodide, benzyl-tri-meta-tolylphosphonium chloride, benzyl-tri-meta-tolylphosphonium bromide, benzyl-tri-meta-tolylphosphonium iodide, benzyl-tri-ortho-tolylphosphonium chloride, benzyl-tri-ortho-tolylphosphonium bromide, benzyl-tri-ortho-tolylphosphonium iodide, tetramethylene bis(triphenyl phosphonium chloride), tetramethylene bis(triphenyl phosphonium bromide), tetramethylene bis(triphenyl phosphonium iodide), pentamethylene bis(triphenyl phosphonium chloride), pentamethylene bis(triphenyl phosphonium bromide), pentamethylene bis(triphenyl phosphonium iodide), hexamethylene bis(triphenyl phosphonium chloride), hexamethylene bis(triphenyl phosphonium bromide), hexamethylene bis(triphenyl phosphonium iodide), tetradecyltributylphosphonium bromide or any combination thereof.

Particularly suitable phosphonium compounds which can be employed herein include, for example, methyltriphenylphosphonium iodide, ethyltriphenylphosphonium iodide, tetrabutylphosphonium iodide, methlytriphenylphosphonium acetateacetic acid complex, ethyltriphenylphosphonium acetateacetic acid complex, tetrabutylphosphonium acetateacetic acid complex, methyltriphenylphosphonium bromide, ethyltriphenylphosphonium bromide, tetrabutylphosphonium bromide, tetradecyltributylphosphonium bromide, ethyltriphenylphosphonium phosphate, benzyl-tri-para-tolylphosphonium chloride, benzyl-tri-para-tolylphosphonium bromide, benzyl-tri-para-tolylphosphonium iodide, benzyl-tri-meta-tolylphosphonium chloride, benzyl-tri-meta-tolylphosphonium bromide, benzyl-tri-meta-tolylphosphonium iodide, benzyl-tri-ortho-tolylphosphonium chloride, benzyl-tri-ortho-tolylphosphonium bromide, benzyl-tri-ortho-tolylphosphonium iodide or any combination thereof.

Tertiary amine and amidine and catalysts are suitable when preparing matting agents for coatings involving the reaction of epoxy groups. Specific examples include 2-phenylimidazole and 2-methylimidazole. Quaternary ammonium compounds as analogues to the phosphonium compounds just described are also highly suitable matt activators. Typical examples include tetrahexylammonium bromide and tetrabutylammonium bromide.

Esterification and transesterification catalysts such as metal alkoxides and metal carboxylates are suitable for use with matting agents of this invention designed for polyester primid coatings. Compounds such as hypophosphorus acid and its metal salts are also useful. Sulphonic acid derivatives such as dodecylbenzenesulphonic acid are also suitable, as are phosphoric acids, phosphate esters, and their related amine salts and epoxy adducts.

As indicated above, it has been discovered that these substances enhance the degree of matting attained at a given addition level of matting agent. Typically the matte activator may be added by blending one or more constituents, e.g., catalyst and/or coreactants with the final condensation product. This may generally require adding by weight of the condensation product, 1 to 50% and more typically 5 to 33% of catalyst or co-reactant, i.e., a ratio of condensation product to catalyst and/or co-reactant of 100:1 to 1:1 and more typically 20:1 to 2.1. A ratio of condensation product to catalyst and/or co-reactant of approximately 2:1 to 6:1 is preferred.

Accordingly a preferred embodiment of the inventive product comprises (1) an amide condensation product described above, and (2) an inorganic solid and/or matte activator compound.

Other Optional Additives

If so desired, additives such as those used in conventional coatings can be combined with the condensation product according to the invention. Such additives include, for example, pigments, fillers, degassing agents, flow agents and stabilizers. Suitable pigments are for example inorganic pigments, such as for example titanium dioxide, zinc sulphide, iron oxide and chromium oxide, and also organic pigments such as for example azo compounds and phthalocyanine compounds. Suitable fillers are for example metal oxides, silicates, carbonates and sulphates.

Primary and/or secondary antioxidants, UV stabilizers such as quinones, (sterically hindered) phenolic compounds, phosphonites, phosphites, thioethers and HALS compounds (hindered amine light stabilizers) can for example be used as stabilizers.

Examples of degassing agents are benzoin and cyclohexane dimethanol bisbenzoate. The flow agents include for example polyalkylacrylates, polyvinyl acetyls, polyethyleneoxides, polyethyleneoxide/propyleneoxide copolymers, fluorohydrocarbons and silicone fluids.

Any optional additives and the condensation product can then be blended into the coating mixture using conventional means. The final matting agent composition can be incorporated as a dry blend with coating binders, or it can be combined with those binders in, for example an extruder, to form particles containing binder, matting agent and any other additive introduced into the extruder. In liquid coatings, the final matting agent can be incorporated as a solid, as a liquid as a solution or as a dispersion in organic solvents or in aqueous media depending on the precise composition of the matting agent and the nature of the coating to be matted.

Matting Mechanism

Generally speaking, matting products used in traditional solvent borne coatings are not widely successful when used in powder coatings primarily because those products are not compatible with or designed to specifically function within the mechanism in which powder coatings form a film. It has been found that while traditional matting products can reduce gloss, more often than not they cause film imperfections and other film failures.

More particularly, powder coatings are designed to flow during heating. As a result, the selection of polymers and crosslinkers for those coatings are based on molecular weight, degree of branching and functionality so that after application of the solid powder particles to a suitable substrate, usually a metallic substrate, the individual polymer particles can collapse together and coalesce during heating. Crosslinking reactions occur subsequently, so that a smooth, continuous and hard film of good quality is formed. Particle collapse and flow of the initial dry powder structure can occur quite rapidly and a glossy surface is observed within a minute or two at normal cure temperatures, e.g., 120-200° C.

At the stage when the film first shows a glossy finish, surface roughness is still present. Indeed, the height roughness may be quite large at this stage. However, the slope of the roughness is expected to determine the gloss, so that if the wavelength is large enough, the perception of a glossy surface will be provided. During further heating and continuing coalescence, the slope of the surface roughness may stay approximately the same and the film stays glossy.

On the other hand, if the powder coating particles do not have sufficient opportunity to flow, e.g., flow is physically impaired, a textured surface may develop, or alternatively, visually rough surfaces with poor film properties may be obtained. Traditional matting products may be used to reduce the gloss of powder coatings to some extent, but as indicated above this approach is normally limited to low volume amounts and when gloss levels above 60 units at 60° are acceptable. Even then, impairment of film properties may result.

Physical flow impairment is also regarded as occurring if the molecular weight of the binder polymer is too high, or if the functionality of the polymer or crosslinker is too high. Particles sizes of the binder polymer also can be large enough to impair coalescence and subsequent flow.

However, moderately hindered flow should permit the slope of the surface roughness to increase during heating following the stage of initial flow and coalescence so that a matt surface can be created from an initially glossy one, since at this stage, flow processes are still occurring.

Accordingly, and without being held to any particular theory, a suitable matting agent for powder coatings should be able to provide for an increase in the slope of the surface roughness of the powder coating during film formation as a result of chemical reaction. More specifically, a suitable matting agent hinders powder coating flow after the powder has formed the initial glossy state. This may occur by means of molecules having a suitable density and distribution of reactive groups. These methods can be classified as essentially chemical or reactive in nature as opposed to the essentially physical or non-reactive methods associated heretofore with the use of typical fillers and waxes.

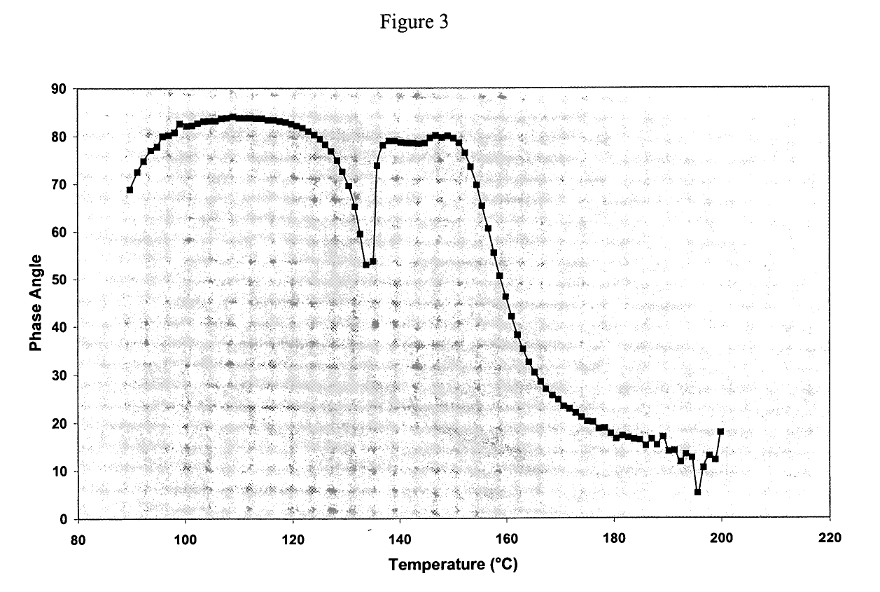

However, care should be taken not to introduce compounds that result in a high degree of flow inhibition or are so reactive that significant network formation occurs too early in the curing schedule of the powder coating, as this may negatively influence film appearance and film properties as described earlier. FIG. 3 shows linear viscoelastic properties of a powder coating cured with crosslinking agents containing only β-hydroxyalkylamide groups. Following an initial decrease in the phase angle as crosslinking reactions begin, at a temperature of 140° C. the phase angle starts to increase again indicating an increase in fluidity, before dropping again at 160° C. as the material solidifies and chemical reactions go towards completion.

Without being held to a particular theory, this may arise as a result of free COOH or OH groups attacking the ester linkage proximally located by the amide group, by transesterification, leading to a temporary decrease in molecule weight, prior to the final molecular weight build-up at higher temperatures as indicated by approach of the phase angle to 0°. This may explain why compounds with a large number of β-hydroxyalkylamide groups per molecular are nevertheless capable of producing glossy powder coating films of good quality.

This data therefore indicates that if the proportion of β-hydroxyalkylamide groups to total functional groups per molecule is too high then matting will not be possible. On the other hand, the functionality content of the inventive composition minimizes that effect because not more than 50% of the total number of functional groups per molecule may be β-hydroxyalkylamide groups. The implication is therefore that the invention is associated with maintaining sufficient flow and reactive capability to produce powder coating films with good appearance and film properties but consistent with the powder coating film being matte. The invention can also avoid the need to adjust the ratio of resin to crosslinker in the base powder coating formulation, which would also be helpful in maintaining film properties insofar that dual functionality is intentionally built into a given compound.

The above discussion relates to powder coatings. The essential point is development of elastic forces at an early stage in film formation coupled with surface flow arising from differential surface tension or an initially undulating surface. This principle can of course be applied to all other coatings. Arranging for the inventive polymer's reactive functional groups to be capable of reacting with the polymer used in the coating is one way to achieve this.

However, this is not the only way, as the inventive polymer's reactive functional groups could also be arranged to chemically bond with inorganic oxides such as silicas or aluminas via for example silane ester groups, amine groups or carboxylic acid groups to produce on addition to the coating a secondary network structure which would also allow earlier development of elastic forces during film formation. Thus, the principle can also be applied to non-reactive coatings as well as reactive coatings.

In a further extension, the approach could also be of value in enhancing the matting properties of conventional matting agents such as silica matting agents.

The principle can be further extended by arranging for the inventive polymer or blend of inventive polymers to have several reactive groups in order to provide for a distribution of reactivity, thereby providing a further mechanism by which the desired elastic component of the coatings Theological response can be built up gradually within the time-scale of the film formation process.

This latter approach could also be implemented in most kinds of coatings. In radiation curing coatings for example, unsaturated groups of differing reactivity could be envisaged, in which the inventive polymers are used alone or in combination with existing techniques such as silicas, waxes and silica/wax combinations.

The aminoalcohols, carboxylic acids, and other compounds employed in preparing the ester, amide, and ester-amide condensation products of this invention can vary and accordingly this invention offers a large number of ways to produce the desired sometimes dual functionality of this invention. Accordingly, the compounds of this invention can even be combined with conventional β-hydroxyalkylamide crosslinkers of the types disclosed in patents referred to above to obtained the desired dual functionality and thus offer additional compounds to control film properties (other than matte) of matted coatings.

In another embodiment, the present invention relates to a coating comprising amide or ester-amide compounds, which provides a reduction in gloss of the coating. Generally, the amide or ester-amide provides a reduction in gloss of the coating at 60° gloss of at least about 5, preferably at least about 10, and more preferably at least about 15. The reduction in gloss may range from about one to about 75 at 60°, preferably about 1 to about 70, and more preferably about 5 to about 65 at 60°.

In a further embodiment, the present invention relates to a coating comprising an amide or ester-amide compound that possesses a functionality of at least four, which yields a coating that possesses a 60° gloss of about 85 or less, preferably about 80 or less, more preferably about 70 or less, and even more preferably about 50 or less. Generally, the coating possesses a 600 gloss from about 15 to about 85, preferably from about 20 to about 80, and even more preferably from about 25 to about 75.

In an embodiment, the present invention relates to a coating composition comprising an amide or ester-amide that is present in the coating in an amount of at least about 1 wt %, preferably at least about 2 wt %, and more preferably at least about 3 wt % by weight of the coating components. Generally, the amide or ester-amide is present in the coating composition in an amount of about 1 to about 30 wt %, preferably about 1 to about 25 wt %, and more preferably about 1 to about 20 wt %.

The preferred embodiments, and modes of operation of the present invention have been described in the foregoing specification. The invention which is intended to be protected herein, however, is not to be construed as limited to the particular embodiments disclosed, since they are to be regarded as illustrative rather than restrictive. Variations and changes, therefore, may be made by those skilled in the art without departing from the spirit of this invention. Further, any range of numbers recited in the specification or claims, such as that representing a particular set of properties, conditions, physical states or percentages, is intended to literally and expressly incorporate herein any number falling with such range, including any subset ranges of numbers with a range so recited. The examples given below therefore only illustrate preparation of the matting compounds described herein and tested in the particular coatings mentioned below in order to merely illustrate gloss reductions of coatings by means of the chemistry discussed above.

### EXAMPLES

Powder coatings set forth herein utilize epoxy-polyester coating formulations. Matting compounds are added so as to give a volume fraction in the coating of around 0.05 in most cases, with the proportion of polyester and epoxy being simultaneously adjusted as needed to accommodate the functionality of the matting compounds.

As a reference point, Ciba 3557, a commercially available reactive matting agent is used in the same manner as set forth herein with simultaneous adjustment of the proportion of epoxy and polyester resins. Polyester-Primid coatings are also employed.

### Example 1

1 mole of Primid XL552 having four a β-hydroxyalkylamide groups per molecule is reacted with 2.5 moles of 1,2,4,5 Benzene-tetracarboxylic acid in the presence of silica in the solid state. In this instance, Primid XL552 contains terminal □-hydroxyalkylamide groups and is obtained as discussed earlier by reacting a diester, substantially the dimethyl ester of adipic acid, with two moles of diethanolamine.

Accordingly, 40.3 g of Primid XL552 from Rohm&Haas and 80 g of 1,2,4,5 Benzene-tetracarboxylic acid are dissolved in 53.8 g of water. 41 g of (Syloid C807) silica gel having a pore volume of approximately 2 cc/g is added and the mixture is stirred at room temperature for 1 hour. The excess water is removed by heating at 120° C. with application of a vacuum to 300 mmHg, whereupon the temperature is raised to 150° C. and maintained for 4 hours to allow reaction to take place.

The acid value of the end product is low and did vary compared to the theoretical value of 279 mgKOH/g. The acid values reported in this Example and those that follow are measured using the following method: About 0.5 g of the sample product is added to 100 ml tetrahydrofuran (THF) and stirred for one hour under mild warming (maximum to 35° C.). The solution is titrated at room temperature with aqueous 0.1M KOH against a phenolphthalein indicator to a pink colored end point from which the acid value AV can be calculated as AV=(5.61*V)/S where V is the volume in mls of KOH solution and S is the weight of the dry sample. The organic to inorganic ratio was 2.7:1 by weight. The presence of bonded aggregates may explain the discrepancy in acid values. The density of the final solid product is determined by Pykonometry to be 1.57. This density, together with the theoretical acid value, is used for purposes of calculating powder coating formulations.

The product (Product A) is incorporated into a standard polyester-epoxy powder coating at a volume fraction addition level of 0.05. The composition of the coating on a weight basis is given in the table below.

TABLE 1
Polyester-Epoxy Powder Coating for Product A

| Component | % by Weight |
|---|---|
| Uralac P5071 (Polyester Resin) | 32.79 |
| Araldite GT7004 (Epoxy Resin) | 34.06 |
| Kronos 2310 (Titanium Dioxide) | 26.66 |
| Product A | 5.23 |
| Byk 365P (Flow Agent) | 0.99 |
| Benzoin (Flow and Degassing Agent) | 0.27 |
| | 100 |

The percentage addition of matting agent by weight is therefore 5.2%, 3.8% of which arose from the organic constituent. The powder coating is prepared and tested under the standard conditions discussed later below.

### Example 2

The commercially available crosslinker Primid XL552 is again employed as a compound containing terminal β-hydroxyalkylamide groups. Primid XL552 is reacted with the anhydride functionality of 1,2,4-benzene-tricarboxylic acid anhydride to produce a substantially monomeric ester-amide containing 8 terminal carboxylic acid groups per molecule and combined with Pural 200 (β-AlO.OH) alumina. The pore volume of Pural 200 alumina is 0.6 cc/g.

Thus, 29.67 g of Primid XL552 is charged to a reaction vessel containing N,N-dimethylacetamide (DMA) and after dissolution, 71.16 g of benzene-1,2,4 tricarboxylic acid 1,2-anhydride is added under stirring. The amount of DMA is selected so that the final concentration is 25% by weight. The mixture is heated to 90° C. for 1 hour. The acid value is determined to be 452 mgKOH/g compared to the theoretical value of 402 mgKOH/g. The method to determine acid value is expected to have an error of about ±5%.

The vessel is charged with 168.05 g of Pural 200 and after through mixing, the contents of the reaction vessel are slowly added to 1 liter (L) of distilled water, preheated to 40° C. The precipitate is separated by filtration and washed three times by reslurrying each time in 1 liter of distilled water preheated to 400C. The final precipitate is dried at 90° C. for 16 hours and pulverized. The acid value of the final product is determined to be 100 mgKOH/g compared to the theoretical value of 151 mgKOH/g.

Decomposition and removal of the organic component at 950° C. indicated that the percentage of organic compound is close to the theoretical value of 38%. Bonded aggregates may therefore have formed, thereby affecting acid value measurement. The density of the final solid product is determined by Pykonometry to be 2.1 and this, together with the theoretical acid value, is used for purposes of calculating powder coating formulations.

The product (Product B) is incorporated into a standard polyester-epoxy powder coating at a volume fraction addition level of 0.05. The composition of the coating on a weight basis is given in the table below.

TABLE 2
Polyester-Epoxy Powder Coating for Product B

| Component | % by Weight |
|---|---|
| Uralac P5071 (Polyester Resin) | 35.74 |
| Araldite GT7004 (Epoxy Resin) | 29.92 |
| Kronos 2310 (Titanium Dioxide) | 26.20 |
| Product B | 6.88 |
| Byk 365P (Flow Agent) | 0.27 |
| Benzoin (Flow and Degassing Agent) | 0.99 |
| | 100 |

The percentage addition of matting agent by weight is therefore, 6.9%, 2.6% of which arose from the organic constituent. The powder coating is prepared and tested under the standard conditions discussed below.

### Example 3

By an alternative method, a non-linear polymeric ester-amide with terminal carboxylic acid groups and only terminal amide groups is prepared by transesterifying 4.5 moles of dimethyl adipate with 1 mole of trimethylolpropane, followed by subsequent reaction of the remaining ester groups with 6 moles of diethanolamine, followed by further reaction with 12 moles of 1,2,4-benzene tricarboxylic acid anhydride. Thus, 10.3 g of trimethylolpropane is melted at a temperature of 60° C. and charged to a reactor. 60.1 g of dimethyladipate is blended in followed by 0.1 g of a transesterification catalyst.

Under a nitrogen atmosphere, the temperature is raised to 120° C. and then again gradually to 150° C. and held there for a period of 4 hours. A vacuum of 300 mmHg is applied and held for a further four hours. The distillate has a refractive index of 1.3369, indicating methanol. The reactor is subsequently charged with 48.4 g of diethanolamine and under a nitrogen atmosphere, heated at 120° C. for four hours. A vacuum of 300 mmHg is applied and the resulting distillate has a refractive index of 1.3358, indicating methanol.

176.8 g of 1,2,4-benzene tricarboxylic acid anhydride dissolved in 296 g of dimethylacetamide is added to the reactor and the mixture is heated under reflux for a period of four hours at 90° C. The acid value is determined to be 399 mgKOH/g compared to the theoretical value of 377 mgKOH/g.

The vessel is charged with 493 g of Pural 200, and after through mixing, the contents of the reaction vessel are slowly added to 2.5 L of distilled water at room temperature. The precipitate is separated by filtration and washed three times by reslurrying each time in 2.5 L of distilled water. The final precipitate is dried at 95° C. for 16 hours and pulverized. The acid value of the final product is determined to be 77 mgKOH/g compared to the theoretical value of 125 mgKOH/g.

Decomposition and removal of the organic component at 950° C. indicated that the percentage of organic compound is at 33%, close to the theoretical value of 38%. Bonded aggregates may therefore have formed, thereby likely causing the measured acid value to vary from the theoretical acid value. The density of the final solid product is determined by Pykonometry to be 2.04, and this, together with the theoretical acid value is used for purposes of calculating powder coating formulations.

The product is labeled product C and its behavior is assessed in a standard polyester-epoxy powder coating at a volume fraction addition level of 0.05. The composition of the coating on a weight basis is given in the table below.

TABLE 2
Polyester-Epoxy Powder Coating for Product C

| Component | % by Weight |
|---|---|
| Uralac P5071 (Polyester Resin) | 38.11 |
| Araldite GT7004 (Epoxy Resin) | 28.51 |
| Kronos 2310 (Titanium Dioxide) | 26.60 |
| Product C | 6.78 (2.6 organic) |
| Byk 365P (Flow Agent) | 0.28 |
| Benzoin (Flow and Degassing Agent) | 1.00 |
| | 100 |

The percentage addition of matting agent by weight is, therefore 6.8%, 2.6% of which arose from the organic constituent. The powder coating is prepared and tested under the standard conditions discussed below.

### Example 4

To illustrate the effect of catalysts and co-reactants, the matting compound described in Example 1 and labeled product A, is tested in combination with tetrabutyiphosphonium bromide according to the formulation given below.

TABLE 4
Polyester-Epoxy Powder Coating for Product A
with tetrabutylphosphonium bromide

| Component | % by Weight |
|---|---|
| Uralac P5071 (Polyester Resin) | 28.22 |
| Araldite GT7004 (Epoxy Resin) | 36.41 |
| Kronos 2310 (Titanium Dioxide) | 26.86 |
| Product A | 5.27 |
| Tetrabutylphosphonium bromide | 1.95 |
| Byk 365P (Flow Agent) | 0.99 |
| Benzoin (Flow and Degassing Agent) | 0.30 |
| | 100 |

As before, the percentage addition of matting agent arising from the organic component amounted to 3.9%. The powder coating is prepared and tested under the standard conditions discussed below.

### Example 5

As a further illustration of the effect of catalysts and co-reactants, the matting compound described in Example 3 and labeled product C, is also tested in combination with tetrabutylphosphonium bromide according to the formulation given below.

TABLE 5
Polyester-Epoxy Powder Coating for Product C
with tetrabutylphosphonium bromide

| Component | % by Weight |
|---|---|
| Uralac P5071 (Polyester Resin) | 33.14 |
| Araldite GT7004 (Epoxy Resin) | 30.41 |
| Kronos 2310 (Titanium Dioxide) | 26.49 |
| Product C | 6.78 |
| Tetrabutylphosphonium bromide | 1.92 |
| Byk 365P (Flow Agent) | 0.99 |
| Benzoin (Flow and Degassing Agent) | 0.30 |
| | 100 |

As before, the percentage addition of matting agent arising from the organic component amounted to 2.6%. The powder coating is prepared and tested under the standard conditions discussed below.

### Example 6

As a further example of a non-linear polymeric ester-amide with terminal carboxylic acid groups, but containing a greater amount of amide groups per molecule than in Example 3, 1 mole of hexahydrophthalic anhydride is reacted with 1.2 moles of diisopropanolamine and subsequently reacted with 1.2 moles of 1,2,4-benzene tricarboxylic acid anhydride. In this instance, the material is prepared without combination with silica or alumina.

Thus, 77 g of hexahydrophthalic acid is heated at a temperature of 45° C. and added to a reactor. 80 g of diisopropanolamine dissolved in 40 g of N-methylpyyrrolidone at the same temperature is subsequently blended in. The temperature is raised to 90° C. and the components allowed to react under reflux in a nitrogen atmosphere for 1 hour with constant stirring. Thereupon, a distillation head is fitted to the apparatus and the temperature slowly raised to 160° C. Distillation is continued for 3 hours, until an acid value of 2 mgKOH/g is attained indicating greater than 98% reaction.

The apparatus is converted back to reflux, 115.2 g of 1,2,4-benzene tricarboxylic acid 1,2-anhydride dissolved in 232 g of N-methylpyrrolidone is added to the reactor and the mixture is heated under reflux for a period of four hours at 90° C. in a nitrogen atmosphere. The acid value is determined to be 270 mgKOH/g compared to the theoretical value of 256 mgKOH/g.

The contents of the reaction vessel are slowly added in a continuous stream to 2.5 L of distilled water at room temperature under intense stirring. The precipitate is separated by filtration and washed three times by reslurrying each time in 2.5 L of distilled water. The final precipitate is dried at 35° C. for 16 hours under vacuum and pulverized. The acid value of the final product is determined to be 246 mgKOH/g compared to the theoretical value of 256 mgKOH/g.

The product is labeled product D and its behavior is assessed in a standard polyester-epoxy powder coating together with tetrabutylphosphonium bromide. The composition of the coating on a weight basis is given in the table below.

TABLE 6
Polyester-Epoxy Powder Coating for Product D

| Component | % by Weight |
|---|---|
| Uralac P5071 (Polyester Resin) | 32.88 |
| Araldite GT7004 (Epoxy Resin) | 32.35 |
| Kronos 2310 (Titanium Dioxide) | 27.06 |
| Product D | 5.19 |
| Tetrabutylphosphonium bromide | 1.04 |
| Byk 365P (Flow Agent) | 0.99 |
| Benzoin (Flow and Degassing Agent) | 0.49 |
| | 100 |

The powder coating is prepared and tested under the standard conditions discussed below.

### Example 7

### Comparative

As a reference point, the commercially available product Ciba 3357 is tested in the standard polyester-epoxy powder coating at a volume fraction of 0.04. The formulation employed is given below.

TABLE 7
Reference Polyester-Epoxy Powder Coating for Ciba 3357

| Component | % by Weight |
|---|---|
| Uralac P5071 (Polyester Resin) | 27.06 |
| Araldite GT7004 (Epoxy Resin) | 40.81 |
| Kronos 2310 (Titanium Dioxide) | 26.89 |
| Ciba 3357 | 3.76 |
| Byk 365P (Flow Agent) | 0.98 |
| Benzoin (Flow and Degassing Agent) | 0.49 |
| | 100 |

The commercially available product is therefore tested at a weight addition level of 3.8%.

### Example 8

### Comparative

As a reference point, a standard unmatted polyester-epoxy powder is prepared according to the formulation given below.

TABLE 8
Unmatted Polyester-Epoxy Powder Coating

| Component | % by Weight |
|---|---|
| Uralac P5071 (Polyester Resin) | 49.80 |
| Araldite GT7004 (Epoxy Resin) | 22.77 |
| Kronos 2310 (Titanium Dioxide) | 27.42 |
| Byk 365P (Flow Agent) | 1.00 |
| Benzoin (Flow and Degassing Agent) | 0.28 |
| | 100 |

### Example 9

### Comparative

As a reference point, a standard unmatted polyester-epoxy powder is prepared containing tetrabutylphosphonium bromide according to the formulation given below.

TABLE 9
Unmatted Polyester-Epoxy Powder Coating
containing tetrabutylphosphonium bromide

| Component | % by Weight |
|---|---|
| Uralac P5071 (Polyester Resin) | 44.60 |
| Araldite GT7004 (Epoxy Resin) | 24.76 |
| Kronos 2310 (Titanium Dioxide) | 27.37 |
| Tetrabutylphosphonium bromide | 1.98 |
| Byk 365P (Flow Agent) | 0.99 |
| Benzoin (Flow and Degassing Agent) | 0.3 |
| | 100 |

### Example 10

As an alternative example of a non-linear polymeric ester-amide having terminal carboxylic acid groups, 1 mole of hexahydrophthalic acid is reacted with 1 mole of diethanolamine followed by reaction with 2 moles of cyclopentanetetracarboxylic acid in the solid state in the presence of silica. Thus, 61.67 g of hexahydrophthalic acid is melted at a temperature of 45° C. and added to a reactor. 42.1 g of diethanolamine is subsequently blended in.

The temperature is raised to 70° C. and the components allowed to react under reflux in a nitrogen atmosphere for 1 hour with constant stirring. The product had an acid value close to the theoretical value of 217 mgKOH/g. 50.5 g of the reaction product is dissolved in 200 g of water, followed by 95.9 g of cyclopentanetetracarboxylic acid and 88 g of a (Syloid C807) silica gel having a pore volume of approximately 2 cc/g.

The excess water is removed by heating at 120° C. with application of a vacuum to 300 mmHg, whereupon the temperature is raised to 150° C. and maintained for 4 hours to allow reaction to take place. The acid value of the end product is determined to be 225 mgKOH/g, about two-thirds of the theoretical value of 330 mgKOH/g. The organic to inorganic ratio is 1.5:1 by weight. The presence of bonded aggregates may have caused the measured acid value to vary from the theoretical acid value. The density of the final solid product is determined by Pykonometry to be 1.57 and this, together with the theoretical acid value, is used for purposes of calculating powder coating formulations.

The product is labeled product E and is incorporated into a standard polyester-primid powder coating at a volume fraction addition level of 0.05. The composition of the coating on a weight basis is given in the table below.

TABLE 10
Polyester-Primid Powder Coating composition for Product E

| Component | % by Weight |
|---|---|
| Uralac P860 (Polyester Resin) | 61.31 |
| Primid XL 552 (Crosslinker) | 5.78 |
| Kronos 2160 (Titanium Dioxide) | 26.46 |
| Product E | 5.19 |
| Byk 365P (Flow Additive) | 0.27 |
| Benzoin (Flow and Degassing Additive) | 0.99 |
| | 100 |

The percentage addition of matting agent by weight is, therefore 5.2%, 3.1% of which arose from the organic constituent. The powder coating is prepared and tested under the standard conditions discussed below.

### Example 11

### Comparative

As a reference point, a standard unmatted polyester-primid powder is prepared according to the formulation given below.

TABLE 11
Unmatted Polyester-Primid Powder Coating

| Component | % by Weight |
|---|---|
| Uralac P860 (Polyester Resin) | 69.21 |
| Primid XL 552 (Crosslinker) | 3.63 |
| Kronos 2160 (Titanium Dioxide) | 27.16 |
| Byk 365P (Flow Additive) | 1.00 |
| Benzoin (Flow and Degassing Additive) | 0.28 |
| | 100 |

### Example 12

### Gloss and Film Properties of Powder Coatings with Inventive Matting Agent

In all Examples, the general procedure for preparing the powder coating compositions of the above formulations is as follows. Polyester and epoxy resins, or Primid XK552 crosslinker, as appropriate, titanium dioxide, flow and degassing additives together with the matting compound and any other additives are charged in the desired amounts to a Prism Pilot 3 premixer and mixed at 200 rpm for 1 minute. Extrusion was carried out on a Prism 16 mm twin screw extruder with an outlet temperature of 120° C. The extrudate is broken up and milled on a Retsch Ultracentrifugal Mill to an average particle size of about 40 μm. Sieving is employed to remove particles above 100 μm.

The powder coatings are then applied to cold rolled steel test panels (Q-Panel S412) by electrostatic spraying using a Gema PG1 Gun at a tip voltage of 30 kV. The coated panels are cured in an oven at 180° C. for 15 minutes and those panels having film thicknesses in the range of 60-80 μm are selected for testing.

Gloss is determined at 60° by means of a Byk Glossmeter. To assess the extent of chemical reaction following curing of the coatings, the resistance of the film to methyl ethyl ketone (MEK) is determined. This involves rubbing the powder coating film with a cloth soaked in MEK and the resistance is expressed as the number of double rubs required under an approximately 1 Kg load before the underlying metal surface is exposed.

Gardner Impact Testing (ASTM G1406.01) is carried out to assess flexibility. The painted side faces down into the impact tester. The point to first cracking and the point at which adhesion loss occurs are determined. Adhesion loss following impact testing is assessed by applying and removing sticky tape from the impacted region and deciding whether portions of the coating had been removed or not. The results are given in Table 12.

Table 12 represents gloss levels at 60°, MEK resistance and Impact Resistance for various compounds added to a standard epoxy-polyester powder coating (Examples 1-9) or a standard polyester-primid powder coating (Examples 10-11) and applied to cold rolled steel panels (Q-Panels S412) at a film thickness of 60-80 μm.

TABLE 12

| | | | | Impact | Impact |
|---|---|---|---|---|---|
| | Gloss | Appearance | | Cracking | Adhesion |
| Sample | (60°) | Visual | MEK | (inch · lbs) | (inch · lbs) |
| Example 1 | 34 | Smooth | >100 | <4 | 20 |
| Example 2 | 43 | Smooth | >100 | 10 | 40 |
| Example 3 | 43 | Smooth | >100 | 10 | 100 |
| Example 4 | 7 | Smooth* | >100 | 55 | >160 |
| Example 5 | 29 | Smooth | >100 | 20 | >160 |
| Example 6 | 24 | Smooth | >100 | 120 | >160 |
| Example 7 | 50 | Smooth | 50 | 20 | 120 |
| Comparative | | | | | |
| Example 8 | 92 | Slight orange | >100 | >160 | >160 |
| Comparative | | peel | | | |
| Example 9 | 93 | Slight orange | >100 | >160 | >160 |
| Comparative | | peel | | | |
| Example 10 | 52 | Smooth | >100 | <4 | <4 |
| Example 11 | 95 | Slight orange | >100 | >160 | >160 |
| Comparative | | peel | | | |

*Slight yellowing

Examples 1 to 6 demonstrate clear reductions in gloss with reasonable to good retention of film properties compared to Example 7 and to unmatted coatings represented by Example 8.

Example 8 compared to Example 9, shows that addition of tetrabutylphosphonium bromide to the unmatted powder coating formulation alone has no effect on the gloss levels attained, whereas comparison of Examples 1 and 3 with Examples 4 and 5 demonstrates that improvements in both matting and film properties result when matting agents discussed in this work are combined with such catalysts or coreactants.

### Example 13

### The Effect of Addition Level of the Inventive Matting Agent

To illustrate that gloss values may be adjusted by varying the addition levels of the inventive matting agent, the inventive condensation product represented by Example 6 is tested in an epoxy-polyester powder coating together with a matt activator as before, but at different addition levels of the condensation product, keeping the ratio of the condensation product to matte activator constant. The proportion of polyester and epoxy resins are simultaneously adjusted to accommodate the functionality of the matting compound. The formulations (13a, 13b & 13c) prepared are shown in the table 13 below, where all entries are in percent by weight.

TABLE 13

| Component | 13a | 13b | 13c |
|---|---|---|---|
| Uralac P5071 | 49.07 | 38.62 | 32.88 |
| Araldite GT7004 | 22.43 | 29.22 | 32.35 |
| Kronos 2310 | 27.02 | 27.01 | 27.06 |
| Product D | — | 3.06 | 5.19 |
| TBPB | — | 0.61 | 1.04 |
| Byk 365P | 0.99 | 0.99 | 0.99 |
| Benzoin | 0.49 | 0.49 | 0.49 |
| | 100 | 100 | 100 |

TBPB = Tetrabutylphosphonium bromide

The results obtained for each of the three formulations are shown in Table 14. This represents the effect of addition level of the inventive matting agent on matting and film properties, where the ratio of the condensation product to matte activator is held constant

TABLE 14

| | | | | Impact | Impact |
|---|---|---|---|---|---|
| | Gloss | Appearance | | Cracking | Adhesion |
| Formulations | (60°) | Visual | MEK | (inch · lbs) | (inch · lbs) |
| 13a | 92 | Slight Orange | >100 | >160 | >160 |
| | | Peel | | | |
| 13b | 58 | Smooth | >100 | >160 | >160 |
| 13c | 24 | Smooth | >100 | 120 | >160 |

Thus, a decrease in gloss occurs with an increasing proportion of matting compound, coupled with good retention of film properties, demonstrating a further desirable feature of the matting compounds discussed above.

The following examples are intended to show that not all polyesteramide polymers bearing reactive functional groups such as beta-hydroxyalkylamide groups or carboxylic acid groups are useful matting compounds in powder coatings.

### Examples 14-16

Examples 14-16 refer to the preparation of comparative polymers containing β-hydroxyalkylamide groups taken out of the patent literature.

### Example 14

### Comparative

In this Example, the polymer following that of example 3 in U.S. Pat. No. 6,392,006 is prepared whereby 1 mole of hexahydrophthalic anhydride is reacted with 1.2 moles of diisopropanolamine.

Thus, 61.67 g of hexahydrophthalic acid is heated at a temperature of 45° C., added to a reactor, and dissolved in 62.8 g of N-methylpyyrrolidone. 63.93 g of diisopropanolamine, dissolved in 62.8 g of N-methylpyyrrolidone at the same temperature, is subsequently blended in. The temperature is raised to 90° C. and the components allowed to react under reflux in a nitrogen atmosphere for 1 hour with constant stirring. An acid value of 173 mgKOH/g is obtained, compared to the theoretical value of 179 mgKOH/g. Thereupon, a distillation head is fitted to the apparatus and the temperature slowly raised to 150° C. Distillation is continued for 13 hours, until an acid value of <3 mgKOH/g is attained.

174 g of the reacted mixture is slowly added in a continuous stream to 3.2 L of distilled water at room temperature under intense stirring. The precipitate is separated by filtration and washed three times by reslurrying each time in 1.5 L of distilled water. The final precipitate is dried at 45° C. for 70 hours and pulverized. The acid value of the final product, labelled product R1 is determined and found to be <4 mgKOH/g.

### Example 15

### Comparative

In this instance, a polymer is prepared following that of the example given in U.S. Pat. No. 6,645,636. In this case, 3.3 moles of hexahydrophthalic anhydride are reacted with 1 mole of diisopropanolamine to produce a polymer having an acid value of 222 mgKOH/g, but for purposes of the present work, a ratio of 3:1 (anhydride to amine) is employed.

Thus, 35.56 g of diisopropanolamine dissolved in 68.10 g of N-methylpyyrrolidone are added to a reactor, followed by 123.34 g of molten hexahydrophthalic acid under stirring such that the temperature remained below 120° C. Reflux is carried out for 1 hour at 90° C., whereupon an acid value of 327 mgKOH/g is found. Thereupon, a distillation head is fitted to the apparatus and the temperature slowly raised to 170° C. Distillation is continued for 5.5 hours, at which point the acid value is observed to be fairly constant at about 326 mgKOH/g.

The reaction mixture is cooled and diluted to 50% concentration with N-methylpyyrrolidone. 150 g of the resulting solution is slowly added in a continuous stream to 3 L of distilled water at room temperature under intense stirring. The precipitate is separated by filtration and washed three times by reslurrying each time in 3 L of distilled water. The final precipitate is dried at 70° C. for 120 hours, following 48 hours of standing at room temperature. The resulting brittle mass is pulverized just prior to use. The acid value of this final product is determined to be 207 mgKOH/g and labeled product R2.

### Example 16

### Comparative

In this Example, an attempt was made to prepare the polymer of example 1 in U.S. Pat. No. 6,5,589,126 by transesterification, whereby 3.21 moles of dimethylphthalate and 0.80 moles of cyclohexane-1,4-dicarboxylic acid dimethylester are transesterified with 4.82 moles of neopentyl glycol. The reaction product is used to transesterify 1.07 moles of dimethyladipate and the product resulting from this step is reacted further with 1.07 moles of 1-amino-2-propanol.

Thus, 50.20 g of neopentyl glycol, 62.34 g dimethylphthalate, 16.02 g of cyclohexane-1,4-dicarboxylic acid dimethylester and 6.51 g of a 30% solution of sodium methylate in methanol aree charged to a reactor. The reactor is heated to 160° C. and distillation continued until methanol ceased to distill over. 90 g of the resulting cooled reaction product is then combined with 18.64 g of dimethyl adipate and 2.19 g of 30% sodium methylate and distillation continued at 160° C. On cooling, 8.04 g of 1-Amino-2-propanol is added together with 2.19 g of 30% sodium methylate and distillation carried out at 120° C. On cooling, a creamy non-solid mass is obtained, labelled R3, but due to its physical form, it was unsuitable for testing in a powder coating.

The powder coating formulations employed to test the matting properties of the above comparative polymers against the inventive polymers are set out in Table 15. For the purpose of the comparison, examples 3 and 6 containing the inventive polymers are also shown in Table 15.

### Example 17

The polymer of Example 6 is substantially repeated with slight modification as follows. Thus, 40.08 g of hexahydrophthalic acid is heated at a temperature of 45° C., added to a reactor, and dissolved in 40.69 g of N-methylpyyrrolidone. 41.29 g of diisopropanolamine, dissolved in 40.68 g of N-methylpyyrrolidone at the same temperature is subsequently blended in. The temperature is raised to 90° C. and the components allowed to react under reflux in a nitrogen atmosphere for 1 hour with constant stirring. An acid value of 188 mgKOH/g is obtained, compared to the theoretical value of 179 mgKOH/g. Thereupon, a distillation head is fitted to the apparatus and the temperature slowly raised to 150° C. Distillation is continued for 11 hours, until an acid value of less than 3 mgKOH/g is attained.

The apparatus is converted back to reflux and 59.56 g of 1,2,4-benzene tricarboxylic acid 1,2-anhydride dissolved in 78.26 g of N-methylpyrrolidone, is added to the reactor. The mixture is heated under reflux for a period of one hour at 90° C. in a nitrogen atmosphere. The resulting acid value is determined to be 262 mgKOH/g compared to the theoretical value of 256 mgKOH/g.

The contents of the reaction vessel are slowly added in a continuous stream to 2.5 L of distilled water at room temperature under intense stirring. The precipitate is separated by filtration and washed three times by reslurrying each time in 2.5 L of distilled water. The final precipitate is dried at 35° C. for 16 hours under vacuum and pulverized. The acid value of the final product is determined to be 227 mgKOH/g compared to the theoretical value of 256 mgKOH/g.

In this case the polymer is tested in a polyester-epoxy powder coating together with tetra-hexylammonium bromide as a matt activator. The composition of the coating on a weight basis is given in the Table 15 below. The powder coating is prepared and tested under the standard conditions discussed above.

TABLE 15
Powder Coating formulations used to assess the matting properties of
reference polymers compared to the inventive polymers

| | R1 + THABr* | R2 | R2 + THABr* | | |
|---|---|---|---|---|---|
| | (Example 14) | (Example 15) | (Example 16) | Example 3 | Example 17 |
| Uralac P5071 | 53.71 | 32.95 | 28.89 | 38.11 | 21.68 |
| Araldite | 12.05 | 32.35 | 34.16 | 28.51 | 39.13 |
| GT7004 | | | | | |
| Kronos 2310 | 27.04 | 26.84 | 26.93 | 26.60 | 26.86 |
| Polymer | 4.29 | 6.38 | 6.40 | 6.78 | 8.53 |
| THABr* | 1.43 | — | 2.14 | — | 2.32 |
| Byk 365P | 0.49 | 0.49 | 0.49 | 0.49 | 0.49 |
| Benzoin | 0.99 | 0.99 | 0.99 | 1.00 | 0.98 |
| | 100 | 100 | 100 | 100 | 100 |

*tetra-hexylammonium bromide

The powder coatings are prepared and applied to steel panels as described earlier. Curing is performed for 10 minutes at 200° C. The results are given in Tables 16 and 17 below, where it is evident that whether a matt activator is present or not, only polymers of the present invention are able to influence significantly the gloss of the coating.

TABLE 16
a). Without matt activator

| | Example 14 | Example 15 | Example 16 | |
|---|---|---|---|---|
| | R1 | R2 | R3 | Example 3 |
| Addition Level | ND | 6.4 | UT | 6.8 |
| Gloss (60°) | ND | 93 | UT | 43 |
| Sheen (85°) | ND | 97 | UT | 52 |
| MEK Resistance | ND | 100 | UT | 100 |
| Impact to first | ND | 36 | UT | 10 |
| crack (in · lbs) | | | | |
| Impact adhesion | ND | 160 | UT | 100 |
| (in · lbs) | | | | |

TABLE 17
b). With matt activator (tetrahexylammonium bromide)

| | Example 14 | Example 15 | Example 16 | |
|---|---|---|---|---|
| | R1 | R2 | R3 | Example 17 |
| Addition Level | 4.3 | 6.4 | UT | 8.53 |
| Gloss (60°) | 92 | 96 | UT | 23 |
| Sheen (85°) | 91 | 95 | UT | 36 |
| MEK | 100 | 100 | UT | 100 |
| Resistance | | | | |
| Impact to first | 10 | 160 | UT | 120 |
| crack | | | | |
| (in · lbs) | | | | |
| Impact | 120 | 160 | UT | 160 |
| adhesion | | | | |
| (in · lbs) | | | | |

ND: Not done as matting is not observed even when using a matt activator.
UT: Not able to test, as the product is not sufficiently solid to incorporate into a powder coating.

### Examples 18-19

Examples 18 and 19 refer to the preparation of two further polymers that are prepared in solution form and used to assess the properties of the inventive substances in liquid coatings.

### Example 18

The polymer of Example 6 is substantially duplicated, except that the molar ratio of reactants is 1 mole of hexahydrophthalic anhydride reacted to 1.2 moles of diisopropanolamine, the resulting product being further reacted with 1 mole of 1,2,4-benzene tricarboxylic acid anhydride. This provided an example of a non-linear ester-amide polymer containing both carboxylic acid groups and a small number of β-hydroxyalkylamide groups.

Thus, 61.67 g of hexahydrophthalic acid is heated at a temperature of 45° C., added to a reactor, and dissolved in 62.8 g of N-methylpyyrrolidone. 63.93 g of diisopropanolamine, dissolved in 62.8 g of N-methylpyyrrolidone at the same temperature is subsequently blended in. The temperature is raised to 90° C. and the components allowed to react under reflux in a nitrogen atmosphere for 1 hour with constant stirring. An acid value of 168 mgKOH/g is obtained, compared to the theoretical value of 179 mgKOH/g. Thereupon, a distillation head is fitted to the apparatus and the temperature slowly raised to 150° C. Distillation is continued for 17 hours, until an acid value of 5 mgKOH/g is attained.

The apparatus is converted back to reflux and to 104 g of product from the first reaction stage, 38.43 g 1,2,4-benzene tricarboxylic acid 1,2-anhydride dissolved in 38.43 g of N-methylpyrrolidone, is added to the reactor. The mixture is heated under reflux for a period of four hours at 90° C. in a nitrogen atmosphere. The resulting acid value is determined to be 250 mgKOH/g compared to the theoretical value of 230 mgKOH/g and the solids content of the solution is 50% by weight.

### Example 19

In this Example, an ester group terminated prepolymer also containing pendent carboxylic acid groups is prepared by reacting dimethyl sebacate, dimethylolpropionic acid and trimethylolpropane, which is then converted with diethanolamine and then again with 1,2,4-benzene tricarboxylic acid anhydride. The molar ratio of reactive ingredients is 3.5:1.26:0.56:2.8:5.6.

Thus, 161.21 g of dimethyl sebacate, 33.53 g dimethylolpropionic acid, 15.03 g of trimethylolpropane and 6.05 g of a 30% solution of sodium methylate in methanol are charged to a reactor. The reactor is heated to 190° C. and distillation continued for 5.5 hours at which point, 27 g of distillate is collected. 58.93 g of diethanolamine together with 4.03 g of 30% sodium methylate is then added to 188.90 g of the prepolymer from the first stage.

The reaction mixture is heated at 140° C. for 4 hours, whereupon, about 20 g of distillate is collected. To 116g of this reaction product, 53.78 g of 1,2,4-benzene tricarboxylic acid 1,2-anhydride dissolved in 133.11 g of N-methylpyrrolidone is added and the mixture stirred under reflux at 90° C. for 1 hour. On cooling, the acid value is found to be 208 mgKOH/g and the solids content is 55% by weight.

### Examples 20-24

### Tests in Coil Coatings

To exemplify the use of the inventive polymers in liquid coatings, their influence on gloss, scratch resistance, and metal marking in solvent-borne coil coatings is assessed. In this work, several techniques are utilised to assess scratch and metal marking resistance, and these are briefly described here. Gloss is assessed in the normal way by the method described earlier herein.

Scratch resistance is determined by means of a Gardener Balanced Beam Scrape Adhesion and Mar Tester as referred to in ASTM D2197. In this method, the tip of a probe attached to a beam is pressed down into a test surface under a predetermined load, which can be varied as desired. The test surface is then drawn uniformly by hand under the probe at a rate of about 5 cm/second. The arrangement is such that the beam is uniformly loaded so as to provide a clearly defined load under which the probe tip continually contacts the test surface. The load in Kg at which the probe just penetrated the coating is taken as a measure of scratch resistance.

The fact that paint removal occurred indicates that the values obtained would have been influenced by adhesion of the coating to the substrate and so the values obtained are to some extent a measure of adhesion as well. For purposes of the work, two types of probe are used as supplied with the equipment. These include a hardened metal needle stylus and a hardened metal loop stylus.

The same piece of equipment is utilised to assess metal marking resistance. In this case, a copper or aluminium flat disc, 0.9 cm in diameter is used as the probe. Drawing the test surface under the loaded disc resulted in varying degrees of marking dependent on the magnitude of the load and the nature of the test surface. Marking occurs as a result of metal being transferred from the disc to the test surface, which thereby becomes discoloured over a narrow band at the point of contact of the disc with the test surface.

Either the % average 60° gloss difference or the % average ΔE value, determined in turn from CIELAB L.a.b colour coordinates, before and after marking are used as a measure of change of the test surface. L.a.b values are determined by means of an X-Rite Spectrodensiometer. Marking is carried out under a load of 0.25, 1, 2, 3, 4 and 6 Kg producing six separate marking bands. The positioning of the marking bands was predetermined, so as to render possible gloss and ΔE values to be determined before and after marking at the same locations.

Gloss and ΔE values are determined at six separate positions along the marking bands after marking and at their predetermined locations before marking. Each set of 36 gloss or ΔE differences are then averaged to produce an overall measure of change of the test surface after marking. For comparison, marking is also assessed visually on a scale of 0 to 5, where larger numbers signify greater marking.

As discussed earlier herein, it is often found that the properties of liquid coatings deteriorate with increasing amounts of typical silica matting agents. The effect of increasing silica levels in polyester coil coating topcoats on gloss, scratch and metal marking resistance is therefore investigated by means of the previously described techniques to provide a reference point, against which the influence on these properties of small additions of the inventive polymers are judged.

### Examples 20-22

The following three examples 20-22 show that metal marking is present in the unmatted polyester coil coating topcoat employed and that both scratch resistance and metal marking deteriorate as the amount of silica added increases and the gloss decreases.

### Example 20

Syloid C809 is added at increasing addition levels up to 3.5% by weight based on the liquid coating, which is a standard commercial white polyester coil coating topcoat from Sigma Coatings, labelled polyester coil coating A. Incorporation of the matting agent is carried out in a conventional way, under high speed dispersion making use of a Dispermat CV. The coatings are applied to a dry film thickness of 15-20 μm on aluminium test panels (A412 test panels from Q-Panels).

The coatings are cured by placing them in an oven at 350° C. for about 25 seconds, so as to achieve a peak metal temperature of 224-232° C. Gloss, scratch and marking resistance are determined as a function of addition level and the results are shown below in Table 18.

TABLE 18
Effect of addition level of a silica matting agent on gloss, metal marking
and scratch resistance of a polyester coil coating (A)
applied at 15-20 μm to aluminium substrates

Addition level of Syloid
C809 (% by weight)

| Properties | 1.5 | 2 | 2.5 | 3 | 3.5 |
|---|---|---|---|---|---|
| Gloss (60°) | 45.6 | 38.1 | 29.4 | 24.1 | 17.9 |
| Needle scratch | 0.8 | 0.8 | 0.6 | 0.4 | 0.2 |
| resistance (Kg) | | | | | |
| Marking Index | 1.1 | 0.9 | 0.9 | 0.6 | 0.4 |
| (% Gloss differential) | | | | | |
| Marking (Visual) | 2 | 2.5 | 3 | 3 | 3.5 |

### Example 21

In this Example, Syloid ED30 (available from Grace GmbH & Co. KG) is added at increasing addition levels up to 5% by weight based on the liquid coating, using the same standard commercial white polyester coil coating topcoat from Sigma Coatings, labelled polyester coil coating A. Incorporation of the matting agent, application and curing of the coatings is the same as given in Example 20 and the results for gloss, scratch and marking resistance are shown in Table 19 below.

TABLE 19
Effect of addition level of a silica matting agent on gloss and metal
marking of a polyester coil coating (A) applied at 15-20 μm to
aluminium substrates

| | Addition level of Syloid ED30 | | | | |
|---|---|---|---|---|---|
| | (% by weight) | | | | |
| Properties | 0 | 2 | 2.5 | 3.5 | 5 |
| Gloss (60°) | 96 | 57 | 47 | 35 | 21 |
| Needle scratch | ND | ND | ND | ND | ND |
| resistance (Kg) | | | | | |
| Marking Index | 0.46 | 0.32 | 0.42 | 0.5 | 0.68 |
| (% L.a.b differential) | | | | | |
| Marking (Visual) | 1.5 | 2 | 3 | 3.5 | 4 |

### Example 22

In this Example, Syloid 244 (available from Grace GmbH & Co. KG) is added at increasing addition levels up to 4% by weight based on the liquid coating, which is again the standard white polyester coil coating topcoat from Sigma Coatings labelled polyester A. Incorporation of the matting agent, application and curing of the coatings is the same as given in example 21 and the results for gloss, scratch and marking resistance are shown in Table 20 below.

TABLE 20
Effect of addition level of a silica matting agent on gloss and metal
marking of a polyester coil coating (A) applied at 15-20 μm to
aluminium substrates

| | Addition level of Syloid 244 | | | | |
|---|---|---|---|---|---|
| | (% by weight) | | | | |
| Properties | 0 | 2 | 3 | 3.5 | 4 |
| Gloss (60°) | 90 | 78 | 57 | 42 | 28 |
| Needle scratch | ND | ND | ND | ND | ND |
| resistance (Kg) | | | | | |
| Marking Index | 0.46 | 0.36 | 0.72 | 1.3 | 1.3 |
| (% L.a.b differential) | | | | | |
| Marking (Visual) | 1 | 1.5 | 1.5 | 2 | 3.5 |

### Examples 23-24

The next two examples, 23 and 24, demonstrate some of the benefits of using the inventive polymers in liquid coatings such as coil coatings. The examples refer to the use of the inventive polymers in combination with conventional silica matting agents.

### Example 23

This example shows how gloss is reduced further by addition of the polymers to a coating matted to a low gloss value with silica and that marking and scratch resistance are significantly improved compared to the coating containing only silica.

A white polyester coil coating topcoat matted to a 60° gloss of 11 units with Syloid ED5 (available from Grace GmbH & Co KG) is prepared, according to the formulation shown in Table 21 and labelled polyester coil coating B.

TABLE 21
Formulation for white matte polyester coil coating topcoat B

| Item Number | Component | Supplier | Parts by weight |
|---|---|---|---|
| 1 | Dynapol LH830 (60%) | Degussa | 25.00 |
| 2 | Aerosil 200 | Degussa | 0.20 |
| 3 | TiO₂ CL310 | Kronos | 22.60 |
| 4 | Butyldigylcol | | 4.00 |
| 5 | Disparlon L1984 | Kusumoto | 1.00 |
| 6 | Solvesso 200 | | 7.00 |
| 7 | Dynapol LH830 (60%) | Degussa | 24.00 |
| 8 | Syloid ED5 | Grace | 4.50 |
| 9 | Solvesso 200 | | 5.50 |
| 10 | Butyldigylcol | | 4.00 |
| 11 | Cymel 303 | Cytec | 7.00 |
| 12 | Byk Catalyst VP450 | Byk-Chemie | 0.20 |
| 13 | Katalysator 1203 | Degussa | 1.00 |
| 14 | Epikote 828 | Shell | 1.00 |
| 15 | Solvesso 150 | | 3.80 |
| | | | 100.00 |

Items 1 to 6 are mixed together and dispersed to a Hegman value of 10-15 μm. Items 7 to 10 are then mixed and dispersed to a Hegman value of 20-25 μm. The two parts are blended together and items 11 to 15 added to the whole under stirring.

The liquid coating prepared is divided into three parts. One part was set aside. To the other two parts are added 2% by weight based on the liquid coating of either the polymer of Example 18 or Example 19 under stirring, so that the effective addition of the solid inventive polymer is about 1% by weight.

The three coatings are applied to a dry film thickness of 15-20 μm on aluminum test panels (A412 test panels from Q-Panels) and cured to a peak metal temperature of 224-232° C. as in the previous experiments. Gloss, scratch and marking resistance for the various coatings are determined and the results are shown in Table 22 below.

TABLE 22
Effect of 1% reactive polymeric matting components (polymers of
Examples 18 and 19) on gloss reduction and film properties of a
polyester coil coating (B) previously matted with Syloid ED5 to 11
gloss units and applied at 15-20 μm to aluminium
substrates

| | Type of polymer | | |
|---|---|---|---|
| | added to polyester | | |
| | coil coating topcoat B | | |
| | | Polymer | Polymer |
| Properties | None | Example 18 | Example 19 |
| Gloss (60°) | 11 | 6 | 8 |
| Loop scratch resistance (Kg) | 3 | 6.5 | 6.5 |
| Needle scratch resistance (Kg) | 0.45 | 5 | 5 |
| Marking Index (% Gloss differential) | 4.3 | 1.9 | −1.2 |
| Marking (Visual) | 4 | 3 | 2.5 |

### Example 24

This example shows how gloss and sheen are significantly reduced by addition of the polymers at comparatively low addition levels of silica and that despite the reduction in gloss, metal marking and scratch resistance do not become worse even in comparison to the unmatted coating. The formulations employed for this purpose are given below in Table 23.

TABLE 23
Formulations for investigating the influence of the inventive polymers
on gloss, scratch resistance and metal marking resistance

| Item Number | Component | F1 | F2 | F3 | F4 |
|---|---|---|---|---|---|
| 1 | Dynapol LH830 | 18.65 | 23.34 | 21.35 | 26.70 |
| | (60%) | | | | |
| 2 | Aerosil 200 | 0.20 | 0.20 | 0.20 | 0.20 |
| 3 | TiO₂ CL310 | 23.79 | 14.89 | 14.85 | 8.51 |
| 4 | Butyldigylcol | 4.13 | 4.13 | 4.13 | 4.13 |
| 5 | Disparlon L1984 | 0.98 | 0.98 | 0.98 | 0.98 |
| 6 | Solvesso 200 | 6.66 | 6.66 | 6.17 | 6.66 |
| 7 | Example 18 | 0.00 | 0.00 | 1.93 | 0.00 |
| | polymer | | | | |
| 8 | Dynapol LH830 | 18.65 | 23.34 | 21.35 | 26.70 |
| | (60%) | | | | |
| 9 | Syloid ED5 | 0.00 | 1.86 | 1.86 | 3.19 |
| 10 | Solvesso 200 | 6.66 | 6.66 | 6.16 | 6.66 |
| 11 | Butyldigylcol | 4.13 | 4.13 | 4.13 | 3.84 |
| 12 | Cymel 303 | 5.59 | 7.00 | 8.47 | 8.01 |
| 13 | Byk Catalyst | 0.20 | 0.20 | 0.20 | 0.20 |
| | VP450 | | | | |
| 14 | Katalysator 1203 | 0.98 | 0.98 | 0.98 | 0.98 |
| 15 | Solvesso 150 | 8.09 | 5.26 | 6.46 | 3.24 |
| 16 | Butyl Glycol | 1.32 | 0.37 | 0.78 | 0.00 |
| | | 100.00 | 100.00 | 100.00 | 100.00 |

Items 1 to 7 are mixed together and dispersed to a Hegman value of 10-15 μm. Items 8 to 11 are mixed and dispersed to a Hegman value of 20-25 μm. The two parts are blended together and items 12 to 16 added to the whole under stirring.

In the above four formulations, the total pigment volume concentration is held constant at 25%. Formulation F1 is prepared without matting additives to produce a glossy coating. Formulations F2 and F4 contains only silica matting agents, while formulation F3 contains silica and an example of the inventive polymer, Example 18. Formulation F4 contains more silica than F2, but less white pigment. In formulation F3, the reactivity of the inventive polymer is taken into account.

As before, the coatings are applied to a dry film thickness of 15-20 μm on aluminium test panels (A412 test panels from Q-Panels) and cured to a peak metal temperature of 224-232° C. as in the previous experiments.

The results for gloss, scratch and marking resistance are shown in Table 24, where the dramatic effect of the inventive polymer in lowering gloss values and maintaining film properties can be seen.

TABLE 24
Effect of 1% reactive polymeric matting Example 18 on gloss reduction
and film properties of polyester coil coating formulations F1 to F4
containing Syloid ED5

| | Addition level of Syloid | | | |
|---|---|---|---|---|
| | ED5 and Polymer (% by weight) | | | |
| Properties | F1 | F2 | F3 | F4 |
| Gloss (60°) | 89 | 50 | 11 | 41 |
| Sheen (85°) | 101 | 69 | 38 | 62 |
| Loop scratch | 1 | 0.85 | 0.95 | 0.9 |
| resistance (Kg) | | | | |
| Needle scratch | 0.75 | 0.35 | 0.4 | 0.4 |
| resistance (Kg) | | | | |
| Marking Index | 1.1 | 0.43 | 0.24 | ND |
| (% Gloss differential) | | | | |
| Marking Index | 0.6 | 0.9 | 0.6 | ND |
| (% L.a.b differential) | | | | |
| Marking (Visual) | 2.5 | 3 | 2 | ND |

1. A coating comprising an amide, wherein said amide provides said coating with a 60° gloss of about 80 or less.

2. A coating according to claim 1, wherein said coating possesses a 60° gloss of about 70 or less.

3. A coating according to claim 1, wherein said coating possesses a 60° gloss of about 60 or less.

4. A coating according to claim 1, wherein said coating possesses a 60° gloss of about 50 or less.

5. A coating according to claim 1, wherein said amide is a monomer, oligomer, or polymer.

6. A coating according to claim 1, wherein said amide comprises at least one reactive functional group including carboxyl, isocyanate, epoxide, hydroxyl, alkoxy silane and vinyl.

7. A coating according to claim 1, wherein the amide comprises at least one β-hydroxyalkylamide functional group.

8. A coating according to claim 7, wherein said β-hydroxyalkylamide functional group is 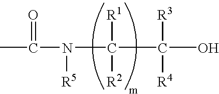
R¹, R², R³ and R⁴ may, independently of one another, be the same or different, H, straight or branched chain alkyl, (C₆-C₁₀) aryl or R¹ and R³ or R² and R⁴ may be joined to form, together with the combinations, a (C₃-C₂₀) cycloalkyl radical; m is 1 to 4 and R⁵ is 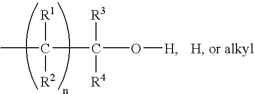
and R¹, R², R³, R⁴ and m as defined above.

9. A coating according to claim 1, wherein said coating is a powder coating.

10. A coating according to claim 1, wherein said amide provides reduction in gloss of said coating.

11. A coating according to claim 1, wherein said amide possesses a total functionality on a mole basis of at least 4.

12. A coating according to claim 1, wherein said amide possesses a total functionality on a mole basis in the range of about 4 to about 48.

13. A coating according to claim 1, wherein said amide possesses a total functionality on a mole basis in the range of about 8 to about 24.

14. A coating according to claim 1, wherein said coating further comprises an inorganic particulate.

15. A coating according to claim 14, wherein the inorganic particulate comprises inorganic oxide.

16. A coating according to claim 14, wherein the inorganic particulate comprises silica or aluminum oxide.

17. A coating according to claim 1, wherein said coating further comprises a matte activator.

18. A coating according to claim 17, wherein the matte activator is a hydrocarbyl phosphonium salt or hydrocarbyl ammonium salt.

19. A coating comprising an amide, wherein said amide provides a reduction in gloss of said coating.

20. A coating according to claim 19, wherein said amide provides a reduction in gloss at 60° gloss of at least about 5.

21. A coating according to claim 19, wherein said amide provides a reduction in gloss at 60° gloss of at least about 10.

22. A coating according to claim 19, wherein said amide provides a reduction in gloss at 600 gloss of at least about 15.

23. A coating according to claim 19, wherein said amide is a monomer, oligomer, or polymer.

24. A coating according to claim 19, wherein said amide comprises at least one reactive functional group including carboxyl, isocyanate, epoxide, hydroxyl, alkoxy silane and vinyl.

25. A coating according to claim 19, wherein the amide comprises at least one β-hydroxyalkylamide functional group.

26. A coating according to claim 7, wherein said β-hydroxyalkylamide functional group is 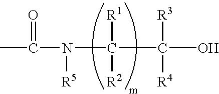
R¹, R², R³ and R⁴ may, independently of one another, be the same or different, H, straight or branched chain alkyl, (C₆-C₁₀) aryl or R¹ and R³ or R² and R⁴ may be joined to form, together with the combinations, a (C₃-C₂₀) cycloalkyl radical; m is 1 to 4 and R⁵ is 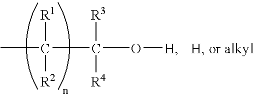
and R¹, R², R³, R⁴ and m as defined above.

27. A coating according to claim 19, wherein said coating is a powder coating.

28. A coating according to claim 19, wherein amide provides improved impact resistance, solvent resistance, scratch resistance, durability, or adhesion to the coating.

29. A coating according to claim 19, wherein said amide possesses a total functionality on a mole basis in the range of about 4 to about 48.

30. A coating according to claim 19, wherein said amide possesses a total functionality on a mole basis of at least 4.

31. A coating according to claim 19, wherein said amide possesses a total functionality on a mole basis in the range of about 8 to about 24.

32. A coating according to claim 19, wherein said coating further comprises an inorganic particulate.

33. A coating according to claim 32, wherein the inorganic particulate comprises inorganic oxide.

34. A coating according to claim 32, wherein the inorganic particulate comprises silica or aluminum oxide.

35. A coating according to claim 19, wherein said coating further comprises a matte activator.

36. A coating according to claim 35, wherein the matte activator is a hydrocarbyl phosphonium salt or hydrocarbyl ammonium salt.

37. A coating according to claim 19, wherein said amide is present in and amount of 1-15 weight % based on the total weight of the coating.
